(19) United States
(12) Patent Application Publication
(10) Pub. No.: US 2015/0033984 A1
(43) Pub. Date: Feb. 5, 2015

(54) CELLULOSE ACYLATE FILM, POLARIZING PLATE, MANUFACTURING METHOD OF POLARIZING PLATE, AND LIQUID CRYSTAL DISPLAY DEVICE

(71) Applicant: FUJIFILM Corporation, Tokyo (JP)

(72) Inventors: Yoshiaki HISAKADO, Kanagawa (JP); Masato NAGURA, Kanagawa (JP)

(73) Assignee: FUJIFILM CORPORATION, Tokyo (JP)

(21) Appl. No.: 14/520,805

(22) Filed: Oct. 22, 2014

Related U.S. Application Data
(63) Continuation of application No. PCT/JP2013/062459, filed on Apr. 26, 2013.

(30) Foreign Application Priority Data
Apr. 27, 2012 (JP) 2012-104200
Jul. 13, 2012 (JP) 2012-158063
Apr. 25, 2013 (JP) 2013-092986

(51) Int. Cl. C08L 1/10; C08K 5/3477; C08K 5/3475; C08K 5/52; C08L 5/00

(52) U.S. Cl. CPC C08L 1/10; C08K 5/52; C08L 5/00; C08K 5/3475; C08K 5/3477
USPC 106/162.9; 106/170.1; 428/220

(57) ABSTRACT

There is provided a cellulose acylate film comprising a plasticizer and two or more kinds of ultraviolet absorbents specific in structure and has a moisture permeability of 1,000 to 1,700 g/m²·day at a temperature of 25° C. and relative humidity of 60%, and a polarizing plate containing at least one cellulose acylate film and a liquid crystal display device containing at least one polarizing plate.

### CROSS REFERENCE TO RELATED APPLICATION

This is a continuation of International Application No. PCT/JP2013/062459 filed on Apr. 26, 2013, and claims priority from Japanese Patent Application No. 2012-104200 filed on Apr. 27, 2012, and Japanese Patent Application No. 2012-158063 filed on Jul. 13, 2012 and Japanese Patent Application No. 2013-92986 filed on Apr. 25, 2013, the entire disclosures of which are incorporated therein by reference.

### TECHNICAL FIELD

The present invention relates to a cellulose acylate film, a polarizing plate, a method for manufacturing the polarizing plate, and a liquid crystal display device.

### BACKGROUND ART

Because liquid crystal display devices (LCDs) are used under environmental conditions including ultraviolet light, there is apprehension that ultraviolet light causes deterioration in performance of polarizers and liquid crystal cells. With this being the situation, polarizer deterioration and liquid crystal cell deterioration from ultraviolet light have been retarded by incorporation of ultraviolet absorbents into optical films for use in LCDs. Therein, ultraviolet absorbents containing halogen elements have been mainly used because they can effectively shift the maximum absorption wavelengths of optical films to longer wavelength side.

In synchronization with recent environmental consideration designing, it has been required to realize optical films containing halogen-free ultraviolet absorbents.

For example, Patent Document 1 has disclosed the cellulose acylate film containing a halogen-free ultraviolet absorbent.

### DOCUMENT ABOUT RELATED ART

### Patent Document

Patent Document 1: JP-A-2011-173964

### SUMMARY OF THE INVENTION

### Problems that the Invention is to Solve

In order to impart desired ultraviolet absorptivity to optical films by the use of halogen-free ultraviolet absorbents, it is required to increase amounts of ultraviolet absorbents incorporated into optical films.

Although we, the present inventors, prepared cellulose acylate films having increased contents of halogen-free ultraviolet absorbents and made polarizing plates through the use of them, it turned out that bleedout of the ultraviolet absorbents occurred during the process of saponifying the films, and thereby the films were whitened. And we found that a rise in the haze value of film on a per-thickness basis was caused by the whitening to result in the display performance being degraded and the display's outward appearance being seriously impaired.

In recent years, as small- to medium-sized liquid crystal display devices including liquid crystal TV sets, tablet PCs, mobile phones and the like have been designed to have lower profiles, it has also been required to reduce thicknesses of optical members, such as polarizing plate protective films, to be used in liquid crystal display devices.

Reduction in thickness causes a rise in moisture permeability of such a film, thereby degrading durability of polarizing plates in humid and hot surroundings. When the moisture permeability is lowered to excess, the moisture drying speed during machining of polarizing plates becomes low, and productivity of polarizing plates is reduced. It is therefore required to design the films to have their moisture permeability within a certain range. Our examination has revealed that durability of polarizing plates in humid and hot surroundings can be made compatible with productivity of the polarizing plates by adjusting moisture permeability of films to fall within a range of 1,000 to 1,700 g/cm²·day.

There has been necessity to realize optical films which, after providing for environmental consideration designing, can be reduced in thickness and have practical ultraviolet absorptivity and ensure durability of polarizers in humid and hot surroundings.

Thus the invention aims to provide a cellulose acylate film which contains no halogen elements, has excellent moisture permeability, can ensure high durability in humid and hot surroundings and high productivity at the occasion when the film and a polarizer are bonded together to produce a polarizing plate, and causes no whitening during a saponification process even when it has a low profile.

### Means for Solving the Problems

By our intensive studies, we have found out that while achieving the desired ultraviolet absorptivity, the combined use of two or more kinds of halogen-free ultraviolet absorbents, at least one of which is an ultraviolet absorbent having two aromatic rings and at least of which is an ultraviolet absorbent having three aromatic rings, can inhibit bleedout at the film surface from occurring even under saponification treatment. We presume that such an effect has been brought about by allowing enhancement of compatibility between cellulose acylate and ultraviolet absorbents through the combined use of the foregoing kinds of ultraviolet absorbents.

Further, by adjusting the moisture permeability of cellulose acylate film to fall within a range of 1,000 to 1,700 g/m²·day, it has become possible to speed up the drying of moisture at the time of polarizing plate machining and enhance the productivity in the production of polarizing plates while changes in polarizer performance during moisture-and-heat treatment are controlled to within an acceptable range.

In addition, moisture permeability can be controlled by incorporating a plasticizer into a cellulose acylate film. This control is supposed to be ascribable to a plasticizer effect that the plasticizer fills up free volume portions of cellulose acylate molecules and provides blockage of hydrogen bonding sites of the cellulose acylate molecules.

More specifically, the invention can be achieved by the following media.

[1] A cellulose acylate film, comprising:

a plasticizer and

two or more kinds of ultraviolet absorbents represented by the following Formula (1):

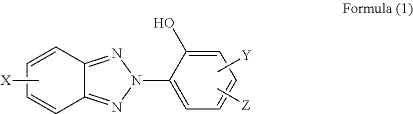

wherein X represents a hydrogen atom, an alkyl group, an alkoxy group, a hydroxyl group, an amino group or an amido group, which may further have a substituent,

in at least one kind of the ultraviolet absorbents, each of Y and Z in Formula (1) independently represents an alkyl group and the alkyl group represented by Y and Z has no aromatic ring as a substituent thereof, and

in at least one kind of the ultraviolet absorbents, each of Y and Z in Formula (1) independently represents an alkyl group and the alkyl group represented by Y and Z has one aromatic ring as a substituent thereof, and

the cellulose acylate film has a moisture permeability of 1,000 g/m²·day to 1,700 g/m²·day at a temperature of 25° C. and relative humidity of 60%.

[2] The cellulose acylate film as described in [1],

wherein the film has a thickness of 15 μm to 40 μm.

[3] The cellulose acylate film as described in [1] or [2],

wherein the plasticizer is a mixture of triphenyl phosphate and biphenyl phosphate.

[4] The cellulose acylate film as described in any one of [1] to [3],

wherein the plasticizer is a plasticizer which has repeating units comprising dicarboxylic acids and diols and is 700 to 10,000 in number average molecular weight.

[5] The cellulose acylate film as described in [4],

wherein the plasticizer is a plasticizer formed from at least one kind of diol selected from an aliphatic diol having a carbon number of 2 to 12, an alkyl ether diol having a carbon number of 4 to 20 or an aromatic ring-containing diol having a carbon number of 6 to 20 and at least one kind of aromatic dicarboxylic acid having a carbon number in a range of 8 to 20.

[6] The cellulose acylate film as described in any one of [1] to [5],

wherein the plasticizer is a plasticizer containing a sugar ester.

[7] The cellulose acylate film as described in any one of [1] to [6], further containing a retardation raising agent.
[8] A polarizing plate, containing at least one cellulose acylate film as described in any one of [1] to [7].
[9] A liquid crystal display device, containing at least one polarizing plate described in [8].
[10] A method of manufacturing a polarizing plate, comprising a process in which at least one sheet of the cellulose acylate film as described in any one of [1] to [7] and a polarizer are bonded together.

### Advantage of the Invention

According to the invention, it is possible to provide a cellulose acylate film which contains no halogen element and causes no whitening during a saponification process even when it is made to have a lower profile.

In addition to the foregoing properties, the present cellulose acylate film is superior in not only excellent moisture permeability but also durability under humid and hot conditions, and it is expected that the present cellulose acylate film will be used as an excellent polarizing plate protective film.

Further, the use of the present cellulose acylate film also makes it possible to provide low-profile polarizing plates and low-profile liquid crystal display devices. By making adjustment to retardation of the present cellulose acylate film in particular, it becomes possible to provide liquid crystal display devices superior in viewing angle and contrast.

### MODE FOR CARRYING OUT THE INVENTION

The invention is illustrated below in detail. Additionally, when numerical values in this description represent physical values, characteristic values and the like, the expressions of “a numerical value 1 through a numerical value 2” and “a numerical value 1 to a numerical value 2” refer to the numbers between or equal to a numerical value 1 and a numerical value 2.

The present cellulose acylate film contains a plasticizer and two or more kinds of ultraviolet absorbents represented by the following structural Formula (1) and has a moisture permeability of 1,000 g/m²·day to 1,700 g/m²·day under conditions that the temperature is 40° C. and the relative humidity is 90%.

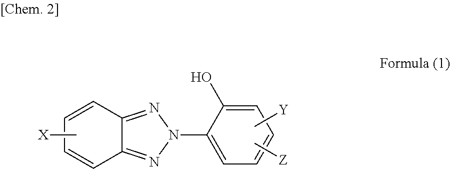

In Formula (1), X represents a hydrogen atom, an alkyl group, an alkoxy group, a hydroxyl group, an amino group or an amido group. These groups may further have substituents if possible.

In at least one kind of the ultraviolet absorbents, each of Y and Z in Formula (1) independently represents an alkyl group and the alkyl group represented by Y and Z has no aromatic ring as a substituent thereof, and

in at least one kind of the ultraviolet absorbents, each of Y and Z in Formula (1) independently represents an alkyl group and the alkyl group represented by Y and Z has one aromatic ring as a substituent thereof.

### [Cellulose Acylate]

The present cellulose acylate film contains a cellulose acylate.

The suitable cellulose acylate content in the present cellulose acylate film is from 70 mass % to 95 mass %, preferably from 75 mass % to 95 mass %, far preferably from 80 mass % to 93 mass %. By having such contents, the present cellulose acylate film allows the making of optical films which ensure excellent workability of polarizing plates.

The cellulose acylate used in the present cellulose acylate film is an ester of a cellulose material and an acid, preferably an ester derived from a carboxylic acid having a carbon number of 2 to about 22, far preferably an ester derived from a lower fatty acid having a carbon number of 6 or less. In the present cellulose acylate film, the degree of substitution of acetic acid and/or fatty acid groups having carbon numbers ranging from 3 to 22 for hydroxyl groups in the cellulose material can be determined e.g. by the method conforming to ASTM D-817-91 or a NMR method. And luminance unevenness in liquid crystal display devices can be improved by preferably using a condensate having repeating units in the case of the cellulose acylate whose acyl is from 2 to about 22 in carbon number, or by preferably using an adduct also in addition to the condensate in the special case of the cellulose acetate whose acetyl is 2 in carbon number.

As cellulose materials usable for the cellulose acylate to be used in the invention, there are cotton linters, wood pulp (including hardwood pulp and softwood pulp) and the like, and a cellulose acylate derived from any of these cellulose materials can be used in the invention. In some instances, cellulose acylate mixtures may be used. Detailed descriptions concerning such cellulose materials can be found in e.g. Marusawa & Uta, Plastic Zairyou Koza (17) Sen-iso-kei Jushi (which might be literally translated “Lectures on Plastic Materials (17) Cellulose Resins”), published by Nikkan Kogyo Shimbun, Ltd. in 1970, and Hatsumei Kyokai Kokai Giho 2001-1745, pp. 7-8. Any of cellulose materials described therein may be used as cellulose for the present cellulose acylate, and there is no particular restriction on cellulose materials to be used for the present cellulose acylate film.

The degree of cellulose hydroxyl substitution in the present cellulose acylate has no particular limits, but for the purpose of imparting appropriate moisture permeability and hygroscopicity to film when the film is used as a polarizing plate protective film or another optical film, it is appropriate that the degree of substitution of acyl groups for cellulose hydroxyl groups be from 2.00 to 3.00; and moreover the substitution degree is preferably from 2.30 to 2.98, far preferably from 2.70 to 2.96, further preferably from 2.80 to 2.94.

The 2C to 22C acyl groups, groups derived from acetic acid and/or 3C to 22C fatty acids, which substitute for cellulose hydroxyl groups have no particular restrictions, and they may be any of aliphatic groups or aromatic groups, and may be used alone or as a mixture of any two or more thereof. Such a cellulose acylate is e.g. an alkylcarbonyl ester of cellulose, an alkenylcarbonyl ester of cellulose, an aromatic carbonyl ester of cellulose or an aromatic alkylcarbonyl ester, and each of these esters may further have a substituent. Examples of such a preferred acyl group include acetyl, propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl and cinnamoyl groups. Among these groups, preferred ones are e.g. acetyl, propionyl, butanoyl, dodecanoyl, octadecanoyl, t-butanoyl, oleoyl, benzoyl, naphthylcarbonyl and cinnamoyl groups, and far preferred ones are acetyl, propionyl and butanoyl groups.

Of these groups, an acetyl group and a mixture of acetyl and propionyl groups, notably an acetyl group, are preferred over the others in terms of ease of synthesis, synthesis cost and easiness of substituent distribution control.

The polymerization degree of a cellulose acylate desirably used in the invention is from 180 to 700 in terms of viscosity-average polymerization degree, and that of cellulose acetate is preferably from 180 to 550, far preferably from 180 to 400, particularly preferably from 180 to 350, in terms of viscosity-average polymerization degree. Too high a polymerization degree of cellulose acylate causes an increase in viscosity of a dope solution of cellulose acylate, and therefore the film formation by casting tends to become difficult. On the other hand, too low a polymerization degree tends to lower strength of the film formed. The average polymerization degree can be determined by the use of the limiting viscosity method of Uta et al. (Uta Kazuo & Saitoh Hideo, Sen-i Gakkaishi (Journal of The Society of Fiber Science and Technology Japan), Vol. 18, No. 1, pp. 105-120, 1962). Details about the average polymerization degree are described in JP-A-9-95538.

Further, the molecular weight distribution of a cellulose acylate desirably used in the invention is evaluated by gel permeation chromatography, and it is appropriate for the cellulose acylate to have a small polydispersity index Mw/Mn (Mw stands for mass-average molecular weight and Mn stands for number-average molecular weight) and a narrow molecular weight distribution. To be more specific, it is appropriate that the Mw/Mn value be from 1.0 to 4.0, preferably from 2.0 to 3.5, especially preferably from 2.3 to 3.4.

Removal of low molecular components, though results in an increase of average molecular weight (polymerization degree), is useful because it can make the viscosity lower than commonly-used cellulose acylates. Cellulose acylate including low molecular components in small quantities can be obtained by removing the low molecular components from cellulose acylate synthesized in a usual way. The removal of low molecular components can be performed by washing cellulose acylate with an appropriate organic solvent. Additionally, in the case of producing the cellulose acylate including low molecular components in small quantities, it is appropriate that the amount of sulfuric acid catalyst used in acetylation reaction be adjusted to fall within a range of 0.5 to 25 parts by mass with respect to 100 parts by mass of cellulose. By adjusting the amount of sulfuric acid catalyst to the foregoing range, cellulose acylate favorable in point of molecular weight distribution (narrow molecular weight distribution) can be synthesized. When such a cellulose acylate is used for forming the present cellulose acylate film, it is appropriate that the cellulose acylate should have a water content of 2 mass % or lower, preferably 1 mass % or lower, particularly preferably 0.7 mass % or lower. In general, cellulose acylate contains water, and the water content therein is known to be within a range of 2.5 to 5 mass %. In order to control the water content in cellulose acylate to the values specified above in the invention, the cellulose acylate require drying, and the drying method thereof has no particular restriction so long as it can attain the intended water content. Detailed descriptions about cotton materials and synthesis methods for cellulose acylates usable in the invention can be found in Hatsumei Kyokai Kokai Giho (which might be translated “Journal of Technical Disclosure issued from Japan Institute for Promoting Invention and Innovation”), Kogi No. 2001-1745, pp. 7-12, published by Hatsumei Kyokai on Mar. 15, 2001.

In the invention, a single cellulose acylate or a mixture of two or more kinds of cellulose acylates can be adopted in terms of substituents, substitution degree, polymerization degree, molecular-weight distribution and so on.

### [Ultraviolet Absorbent]

Ultraviolet absorbents to be used in the invention are described below.

The present cellulose acylate film contains two or more kinds of ultraviolet absorbents. It is particularly preferred that two kinds of ultraviolet absorbents be used.

The two or more kinds of ultraviolet absorbents are halogen-free compounds and represented by the following Formula (1).

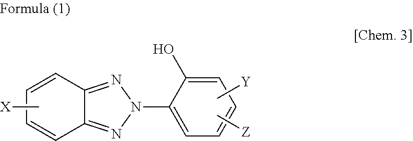

In Formula (1), X represents a hydrogen atom, an alkyl group, an alkoxy group, a hydroxyl group, an amino group or an amido group. These groups may further have substituents if possible.

In at least one kind of the ultraviolet absorbents, each of Y and Z in Formula (1) independently represents an alkyl group and the alkyl group represented by Y and Z has no aromatic ring as a substituent thereof, and

in at least one kind of the ultraviolet absorbents, each of Y and Z in Formula (1) independently represents an alkyl group and the alkyl group represented by Y and Z has one aromatic ring as a substituent thereof.

X is preferably a hydrogen atom, an alkyl group, an alkoxy group or a hydroxyl group. A substituent X may have is a halogen-free group.

In Formula (1), X is far preferably a hydrogen atom, an alkyl group having a carbon number of 1 to 5 or an alkoxy group having a carbon number of 1 to 5, particularly preferably a hydrogen atom.

Examples of the alkyl group having a carbon number of 1 to 5 include a methyl group, an ethyl group, a propyl group, a butyl group, a pentyl group, an isopropyl group, a tert-butyl group, an isobutyl group and a sec-butyl group.

Examples of the alkoxy group having a carbon number of 1 to 5 include a methoxy group, an ethoxy group, a propoxy group, a butoxy group, a pentyloxy group, an isopropoxy group, a tert-butoxy group, an isobutoxy group and a sec-butoxy group.

In at least one kind of the ultraviolet absorbents, each of Y and Z in Formula (1) independently represents an alkyl group and the alkyl group represented by Y and Z has no aromatic ring as a substituent thereof, and

in at least one kind of the ultraviolet absorbents, each of Y and Z in Formula (1) independently represents an alkyl group and the alkyl group represented by Y and Z has one aromatic ring as a substituent thereof.

By the combined use of an ultraviolet absorbent represented by Formula (1) wherein each of Y and Z independently represents an alkyl group and the alkyl group represented by Y and Z has no aromatic ring as a substituent thereof and an ultraviolet absorbent represented by Formula (1) wherein each of Y and Z independently represents an alkyl group and the alkyl group represented by Y and Z has one aromatic ring as a substituent thereof, an effect of preventing occurrence of a whitening phenomenon under saponification treatment can be obtained. As the aromatic rings, benzene rings are suitable.

Each of Y and Z preferably represents a substituted or unsubstituted alkyl group having a carbon number of 2 to 20.

The substituted or unsubstituted alkyl group having a carbon number of 2 to 20 may be linear or branched in shape. Examples of the substituted or unsubstituted alkyl group having a carbon number of 2 to 20 include an ethyl group, an isopropyl group, a tert-butyl group, a tert-amyl group, a tert-octyl group, a hydroxyethyl group, a methoxymethyl group and a butoxyethyl group.

In substituents which Y and Z may have, no halogen elements are included.

The suitable content ratio between an ultraviolet absorbent represented by Formula (1) wherein Y and Z are independent of each other and represent alkyl groups having no aromatic ring as substituents thereof and an ultraviolet absorbent represented by Formula (1) wherein Y and Z are independent of each other and represent alkyl groups having one aromatic ring each as substituents thereof is from 95:5 to 10:90, preferably from 80:20 to 50:50.

In point of spectral transmittance, the suitable total amount of ultraviolet absorbents added is from 0.5 to 10 parts by mass, preferably from 1 to 5 parts by mass, with respect to 100 parts by mass of cellulose acylate.

### [Plasticizer]

The present cellulose acylate film contains at least one kind of plasticizer.

The plasticizer inhibits aggregation of polymer chains from occurring, and contributes to property improvements in terms of haze and brittleness.

In addition, it is supposed that a plasticizer fills up free volume of cellulose acylate and renders hydrogen bonding sites ineffective to result in lowering of moisture permeability.

From the viewpoint of film viscoelasticity, it is appropriate that the plasticizer content be from 5 to 25 parts by mass, preferably from 6 to 20 parts by mass, with respect to 100 parts by mass of cellulose acylate.

As the plasticizer, various plasticizers which have been used so far in cellulose acylate films can be utilized. Among them, a mixture of triphenyl phosphate and biphenyl diphenylphosphate is notably suitable as the plasticizer.

### [High Molecular-Weight Plasticizer]

As the plasticizer, a high molecular-weight plasticizer may be used.

The high-molecular-weight plasticizer which can be used in the invention is characterized as having a molecular weight of 700 to 10,000 and repeating units. Herein, the term “molecular weight of a high-molecular-weight plasticizer” refers to the average molecular weight of a plasticizer, and the plasticizer is a mixture of plasticizer molecules differing in molecular weight. In solution casting, a plasticizer is an essential ingredient for speeding up of the vaporization of solvent and reduction in the amount of residual solvent. Also in a polymer film made by a fusion method, a plasticizer is a useful ingredient for prevention of staining and deterioration in film strength. Further, the addition of such a high-molecular-weight plasticizer to the present polymer film produces useful effects from the viewpoint of reforming the film, including improvements in mechanical properties, impartment of flexibility and water-absorption resistance, reduction in moisture permeability, and so on. Furthermore, the addition of such a high-molecular-weight plasticizer in the invention, as hereinafter shown in Examples, is highly effective in improving handling properties in the manufacturing process.

The high-molecular-weight plasticizer usable in the invention is characterized as having repeating unit portions in its compound. The number-average molecular weight of a high-molecular-weight plasticizer for use in the invention is from 600 to 10,000, preferably from 600 to 8,000, far preferably from 700 to 5,000, particularly preferably from 700 to 3,500.

High-molecular-weight plasticizers for use in the invention may be in a liquid state or in a solid state at ambient temperature and humidity, and their melting temperatures are grouped according to film-making methods adopted in the invention. In cases where solution film-making methods are adopted, the suitable melting temperatures of those plasticizers are in a range of −100° C. to 150° C., preferably −100° C. to 70° C., particularly preferably −100° C. to 50° C. In contrast to such cases, the suitable melting temperatures in cases where fusion film-making methods are adopted are in a range of −100° C. to 200° C., preferably −100° C. to 170° C., particularly preferably −100° C. to 150° C.

In addition, the fainter the tints those plasticizers have, the better they are for use in the invention. And it is best for them to be colorless. From the thermal point of view, it is preferred that they be stable under higher temperatures, and their decomposition starting temperatures are preferably 150° C. or higher, far preferably 200° C. or higher. High-molecular-weight plasticizers may be added in any amounts so long as they have no adverse effects on optical and mechanical properties of the polymer film, and the compounding amounts thereof are selected as appropriate from the range in which the objects of the invention are not spoiled. Specifically, it is appropriate that the high-molecular-weight plasticizer content in the present polymer film be from 1 to 50 mass %, preferably from 2 to 40 mass %, particularly preferably from 5 to 30 mass %, with respect to the amount of polymer used.

High-molecular-weight plasticizers for use in the invention are illustrated below in detail with specific examples, and they are high-molecular-weight plasticizers complying with the following descriptions.

The high-molecular-weight plasticizer which can be used in the present polymer film is a high-molecular-weight plasticizer having a number-average molecular weight of 700 to 10,000. In the polymer film containing the high-molecular-weight plasticizer having repeating units formed from dicarboxylic acids and diols, the dicarboxylic acids for forming the high-molecular-weight plasticizer include at least one alkylenedicarboxylic acid having a carbon number of 2 to 20 and at least one aromatic dicarboxylic acid having a carbon number of 8 to 20, and the diols include at least one or more than one diol selected from a diol having a carbon number of 2 to 20, an alkyl ether diol having a carbon number of 4 to 20 or an aromatic ring-containing diol having a carbon number of 6 to 20 (hereinafter referred to as an aromatic diol, too).

High-molecular-weight plasticizers usable in the invention are further illustrated below. Preferred high-molecular-weight plasticizers have no particular restrictions so long as they are within the scope of the invention.

The high-molecular-weight plasticizer for use in the invention is a compound produced by reaction between a mixture of an aliphatic dicarboxylic acid having a carbon number of 2 to 20 or an aromatic dicarboxylic acid with an aromatic dicarboxylic acid having a carbon number of 8 to 20 and at least one or more than one diol selected from an aliphatic diol having a carbon number of 2 to 12, an alkyl ether diol having a carbon number of 4 to 20 or an aromatic diol having a carbon number of 6 to 20, and both ends of the reaction product may be kept as they are. However, blocking of both ends of the reaction product may further be carried out through the reaction with a monocarboxylic acid, a monoalcohol or a phenol. This end blocking is conducted in order to eliminate free carboxylic acids, and it is effective in terms of keeping quality and so on. Dicarboxylic acids applied to a high molecular-weight plasticizer usable in the invention are preferably aliphatic dicarboxylic acid residues whose carbon numbers are in a range of 4 to 20 or aromatic dicarboxylic acid residues whose carbon numbers are in a range of 8 to 20.

Examples of an aliphatic dicarboxylic acid having a carbon number of 2 to 20 which can be used suitably in the invention include oxalic acid, malonic acid, succinic acid, maleic acid, fumaric acid, glutaric acid, adipic acid, pimelic acid, suberic acid, azelaic acid, sebacic acid, dodecanedicarboxylic acid and 1,4-cyclohexanedicarboxylic acid.

And examples of an aromatic dicarboxylic acid having a carbon number of 8 to 20 include phthalic acid, terephthalic acid, isophthalic acid, 1,5-naphthalenedicarboxylic acid, 1,4-naphthalenedicarboxylic acid, 1,8-naphthalenedicarboxylic acid, 2,8-naphthalenedicarboxylic acid and 2,6-naphthalenedicarboxylic acid.

Of those aliphatic dicarboxylic acids, the preferred are malonic acid, succinic acid, maleic acid, fumaric acid, glutaric acid, adipic acid, azelaic acid and 1,4-cyclohexanedicarboxylic acid; while, of those aromatic dicarboxylic acids, the preferred are phthalic acid, terephthalic acid, isophthalic acid, 1,5-naphthalenedicarboxylic acid and 1,4-naphthalenedicarboxylic acid. Among them, those preferred in particular as aliphatic dicarboxylic acids are succinic acid, glutaric acid and adipic acid, and those preferred in particular as aromatic dicarboxylic acids are phthalic acid, terephthalic acid and isophthalic acid.

In the invention, at least one of the aliphatic dicarboxylic acids as recited above and at least one of the aromatic dicarboxylic acids as recited above are used in combination, and there is no particular restrictions as to what combination is to be made from them. For instance, no problem occurs even if a combination is made with several kinds of aliphatic ones and several kinds of aromatic ones.

In the next place, diols or aromatic ring-containing diols utilized for producing high-molecular-weight plasticizers are mentioned. They are selected from aliphatic diols whose carbon numbers are in a range of 2 to 20, alkyl ether diols whose carbon numbers are in a range of 4 to 20, or aromatic ring-containing diols whose carbon numbers are in a range of 6 to 20.

Examples of an aliphatic diol having a carbon number of 2 to 20 include alkyl diols and alicyclic diols, such as ethanediol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol(3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol and 1,12-octadecanediol. These glycols are used alone or as a mixture of any two or more thereof.

Among the aliphatic diols as recited above, the preferred are ethanediol, 1,2-propanediol, 1,3-propanediol, 1,2-butanediol, 1,3-butanediol, 2-methyl-1,3-propanediol, 1,4-butanediol, 1,5-pentanediol, 3-methyl-1,5-pentanediol, 1,6-hexanediol, 1,4-cyclohexanediol and 1,4-cyclohexanedimethanol, and the particularly preferred are ethanediol, 1,2-propanediol, 1,3-propanediol, 1,2-butanediol, 1,3-butanediol, 1,4-butanediol, 1,5-pentanediol, 1,6-hexanediol, 1,4-cyclohexanediol and 1,4-cyclohexanedimethanol.

Suitable examples of an alkyl ether diol having a carbon number of 4 to 20 include polytetramethylene ether glycol, polyethylene ether glycol, polypropylene ether glycol, and combinations of any two or more thereof. The average polymerization degree of such a diol is not particularly limited, but preferably from 2 to 20, far preferably from 2 to 10, further preferably from 2 to 5, particularly preferably from 2 to 4. Typically useful ones among those glycols are e.g. commercially available polyether glycols, such as Carbowax Resin, Pluronics Resin and Niax Resin.

The aromatic diols having carbon numbers in a range of 6 to 20 are not limited to particular ones, but as examples thereof, bisphenol A, 1,2-hydroxybenzene, 1,3-hydroxybenzne, 1,4-hydroxybenzne and 1,4-benzenedimethanol may be cited. Among them, the preferred are bisphenol A, 1,4-hydroxybenzene and 1,4-benzenedimethanol.

The plasticizer for use in the invention is preferably a high-molecular-weight plasticizer whose end groups are blocked with alkyl groups or aromatic groups. This is because protection of end groups by hydrophobic functional groups is effective against deterioration with time under circumstances of high temperature and high humidity and plays a role in retarding hydrolysis of ester groups.

Both ends of a polyester plasticizer for use in the invention are preferably protected by monoalcohol residues or monocarboxylic acid residues so as not to be carboxylic acid groups or OH groups.

In this case, the alcohol residues are preferably substituted or unsubstituted monoalcohol residues having their carbon numbers in a range of 1 to 30, with examples including residues of aliphatic alcohols, such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecaoctanol, allyl alcohol and oleyl alcohol, and substituted alcohols, such as benzyl alcohol and 3-phenylpropanol.

Examples of a preferably-usable alcohol residue for end-group blocking include residues of methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol and benzyl alcohol, especially residues of methanol, ethanol, propanol, isobutanol, cyclohexyl alcohol, 2-ethylhexyl alcohol, isononyl alcohol and benzyl alcohol.

In the case of blocking with a monocarboxylic acid residue, on the other hand, monocarboxylic acids which can be preferably used for the monocarboxylic acid residue are substituted or unsubstituted monocarboxylic acids having carbon numbers ranging from 1 to 30. These acids may be aliphatic monocarboxylic acids or aromatic ring-containing carboxylic acids. Those suitable as the aliphatic monocarboxylic acids are mentioned first. Examples thereof include acetic acid, propionic acid, butanoic acid, caprylic acid, caproic acid, decanoic acid, dodecanoic acid, stearic acid and oleic acid. As to the aromatic ring-containing monocarboxylic acids, examples thereof include benzoic acid, p-tert-butylbenzoic acid, p-tert-amylbenzoic acid, ortho-toluic acid, meta-toluic acid, para-toluic acid, dimethylbenzoic acid, ethylbenzoic acid, n-propylbenzoic acid, aminobenzoic acid and acetoxybenzoic acid. These acids may be used alone or as mixtures of any two or more thereof.

Those high-molecular-weight plasticizers for use in the invention can be synthesized with ease by the use of usual methods, such as a hot melting condensation method utilizing polyesterification reaction or transesterification reaction occurring between the dicarboxylic acid and diol, and if needed, end group-blocking monocarboxylic acid or monoalcohol as recited above, and a method utilizing interfacial condensation occurring between acid chlorides of those acids and glycols. Detailed description of those polyester plasticizers can be found in Koh-ichi Murai (compiler), Kasozai Sono Riron to Oyo (which might be literally translated “Theories and Applications of Plasticizers”), 1st edition, published by SAIWAI SHOBO on Mar. 1, 1973). In addition, the materials disclosed in JP-A-5-155809, JP-A-5-155810, JP-A-5-197073, JP-A-2006-259494, JP-A-7-330670, JP-A-2006-342227 and JP-A-2007-003679 can also be utilized.

### [Sugar Ester Compounds]

The present film may also contain a sugar ester compound as a plasticizer. The addition of a sugar ester compound to the cellulose acylate film does not impair developability of optical properties, and allows reduction in total haze and internal haze even when heat treatment is not carried out before a stretching process. Further, the use of the present cellulose acylate film in a liquid crystal display device can bring about a substantial improvement in frontal contrast of the liquid crystal display device.

### —Sugar Residue—

The term “sugar ester compound” used above refers to the compound containing as a constituent a monosaccharide or a polysaccharide wherein an ester linkage is formed between at least one among its substitutable groups (e.g. a hydroxyl group, a carboxyl group) and at least one substituent. In other words, the compound called the sugar ester compound herein includes sugar derivatives in a broad sense, such as compounds having sugar residues in their structures, e.g. gluconic acid. More specifically, the term sugar ester compound is intended to include esters of glucose and carboxylic acids and esters of gluconic acid and alcohols, too.

At least one among substitutable groups in a monosaccharide or a polysaccharide as a constituent of the sugar ester compound is preferably hydroxyl group.

In the sugar ester compound is included a structure derived from a monosaccharide or a polysaccharide (hereafter referred to as a sugar residue too) as a constituent of the sugar ester compound. The structure of a sugar residue per monosaccharide is referred to as a structural unit of the sugar ester compound. It is preferred that a pyranose structural unit or a furanose structural unit be included in the structural units of the sugar ester compound, and it is far preferred that all the sugar residues be pyranose structural units or furanose structural units. In the case of a sugar ester formed from a polysaccharide, it is preferred that the sugar ester include both pyranose structural units and furanose structural units.

Sugar residues of the sugar ester compound, though may be those derived from pentose or those derived from hexose, are preferably those derived from hexose.

The suitable number of structural units included in the sugar ester compound is from 1 to 12, preferably 1 to 6, particularly preferably 1 or 2.

The sugar ester compound in the invention is preferably a sugar ester compound containing 1 to 12 pyranose or furanose structural units which each have at least one esterified hydroxyl group, far preferably a sugar ester compound containing 1 or 2 pyranose or furanose structural units which each have at least one esterified hydroxyl group.

Examples of a monosaccharide and a polysaccharide containing 2 to 12 monosaccharide units include erythrose, threose, ribose, arabinose, xylose, lyxose, allose, altrose, glucose, fructose, mannose, gulose, idose, galactose, talose, trehalose, isotrehalose, neotrehalose, trehalosamine, kojibiose, nigerose, maltose, maltitol, isomaltose, sophorose, laminaribiose, cellobiose, gentiobiose, lactose, lactosamine, lactitol, lactulose, melibiose, primeverose, rutinose, scillabiose, sucrose, sucralose, turanose, vicianose, cellotriose, chacotriose, gentianose, isomaltotriose, isopanose, maltotriose, manninotriose, melezitose, panose, planteose, raffinose, solatriose, umbelliferose, lycotetraose, maltotetraose, stachyose, maltopentaose, verbascose, maltohexaose, α-cyclodextrin, β-cyclodextrin, γ-cyclodextrin, δ-cyclodextrin, xylitol and sorbitol.

Among them, the preferred are ribose, arabinose, xylose, lyxose, glucose, fructose, mannose, galactose, trehalose, maltose, cellobiose, lactose, sucrose, sucralose, α-cyclodextrin, β-cyclodextrin, γ-cyclodextrin, δ-cyclodextrin, xylitol and sorbitol, the far preferred are arabinose, xylose, glucose, fructose, mannose, galactose, maltose, cellobiose, sucrose, β-cyclodextrin and γ-cyclodextrin, and the particularly preferred are xylose, glucose, fructose, mannose, galactose, maltose, cellobiose, sucrose, xylitol and sorbitol.

### —Structure of Substituent—

The sugar ester compound for use in the invention, including a substituent used therein, preferably has a structure represented by the following Formula (1A).

(OH)ₚ-G-(L¹-R¹¹)_{q}(O—R¹²)ᵣ Formula (1A)

In Formula (1A), G represents a sugar residue, L¹ represents one of the groups —O—, —CO— and —NR¹³—, R¹¹ represents a hydrogen atom or a univalent substituent, R¹² represents a univalent substituent binding through ester linkage, and R¹³ represents a hydrogen atom or a univalent substituent. Each of p, q and r independently represents an integer of 0 or greater, and p+q+r is equal to the number of hydroxyl groups in the case of assuming that the G is an unsubstituted saccharide having a cyclic acetal structure.

The preferred scope of the G is the same as that of the sugar residue mentioned above.

The L¹ is preferably —O— or —CO—, far preferably —O—. In the case of —O—, it is preferred in particular that the L¹ be a linkage group derived from ether linkage or ester linkage, especially ester linkage.

In addition, when more than one L¹ is present, each L¹ may be the same as or different from every other L¹.

And it is preferred that at least either R¹¹ or R¹² have an aromatic ring.

In the case where the L¹ is —O— (in other words, hydroxyl groups in the sugar ester compound are substituted with R¹¹ and R¹²), each of the R¹¹, the R¹² and the R¹³ is selected preferably from substituted or unsubstituted acyl groups, substituted or unsubstituted aryl groups, substituted or unsubstituted alkyl groups, or substituted or unsubstituted amino groups, far preferably from substituted or unsubstituted acyl groups, substituted or unsubstituted alkyl groups or substituted or substituted aryl groups, particularly preferably from unsubstituted acyl groups, substituted or unsubstituted alkyl groups or unsubstituted aryl groups.

In addition, when more than one R¹¹, more than one R¹² and more than one R¹³ are present, each R¹¹, each R¹² and each R¹³ may be the same as or different from every other R¹¹, every other R¹² and every other R¹³, respectively.

The p represents an integer of 0 or greater, and a preferred range thereof is the same as the range of the number of hydroxyl groups per monosaccharide, and this range is mentioned later.

The r preferably represents a number greater than the number of pyranose structural units or furanose structural units included in the G.

And the q is preferably 0.

In addition, because p+q+r is equal to the number of hydroxyl groups in the case of assuming that the G is an unsubstituted saccharide having a cyclic acetal structure, the upper limits for the p, the q and the r are uniquely determined by the structure of the G

Suitable examples of a substituent of the sugar ester compound include alkyl groups (specifically, alkyl groups having carbon numbers ranging preferably from 1 to 22, far preferably from 1 to 12, particularly preferably from 1 to 8, such as a methyl group, an ethyl group, a propyl group, a hydroxyethyl group, a hydroxypropyl group, a 2-cyanoethyl group and a benzyl group), aryl groups (specifically, aryl groups having carbon numbers ranging preferably from 6 to 24, far preferably from 6 to 18, particularly preferably from 6 to 12, such as a phenyl group and a naphthyl group), acyl groups (specifically, acyl groups having carbon numbers ranging preferably from 1 to 22, far preferably from 2 to 12, particularly preferably from 2 to 8, such as an acetyl group, a propionyl group, a butyryl group, a pentanoyl group, a hexanoyl group, an octanoyl group, a benzoyl group, a toluyl group and phthalyl group), amido groups (specifically, amido group having carbon numbers ranging preferably from 1 to 22, far preferably from 2 to 12, particularly preferably from 2 to 8, such as a formamido group and an acetamido group) and imido groups (specifically, imido groups having carbon numbers ranging preferably from 4 to 22, far preferably from 4 to 12, particularly preferably from 4 to 8, such as a succinimido group and a phthalimido group). Of these groups, alkyl groups and acyl groups are preferred to the others, and methyl, acetyl and benzoyl groups are far preferred. Among them, a benzoyl group is especially preferred.

The number of hydroxyl groups per structural unit in the sugar ester compound (hereafter referred to as the hydroxyl content) is desirably 3 or smaller, more desirably 1 or smaller. Control of the hydroxyl content to the range specified above is favorable from the viewpoint of allowing inhibition of migration of the sugar ester compound into a polarizer layer and destruction of PVA-iodine complex with a lapse of time under circumstances of high temperature and high humidity, and thereby allowing prevention of deterioration in polarizer performance with a lapse of time under circumstances of high temperature and high humidity.

The sugar ester compound can be commercially available as industrial products from Tokyo Chemical Industry Co., Ltd., Aldrich and so on, or can be synthesized by the use of a known method for converting commercially available carbohydrates to ester derivatives thereof (e.g. the method disclosed in JP-A-8-245678).

The suitable number-average molecular weight of the sugar ester compound is from 200 to 3,500, preferably from 200 to 3,000, particularly preferably from 250 to 2,000.

Examples of the sugar ester compound which can be preferably used are illustrated below, but the invention should not be construed as being limited to these embodiments.

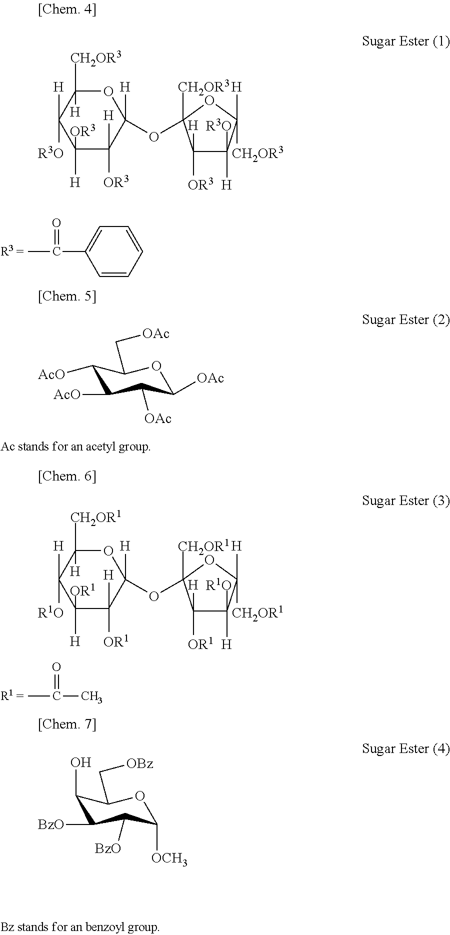

In the following structural formula, Rs are independent of one another, and each R represents an arbitrary substituent and may be the same as or different from every other R. In the following structure, each of Substituent 1 and Substituent 2 represents an arbitrary R. The substitution degree refers to the number of substituents represented by Rs. “Nothing” indicates that R is a hydrogen atom.

The term “ClogP value” refers to the value determined by calculating the common logarithm of 1-octanol/water partition coefficient P, or log P. In calculating the ClogP values, we used the CLOGP program installed in PCModels, a system of Daylight Chemical Information Systems Inc.

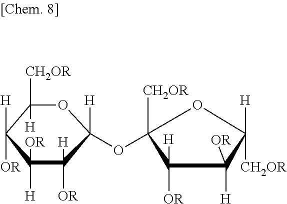

Chem. 9

| | Substituent 1 | | Substituent 2 | | | |
|---|---|---|---|---|---|---|
| | | substi- | | substi- | | |
| Com- | | tution | | tution | | Molecular |
| pound | kind | degree | kind | degree | ClogP | Weight |
| 101 | acetyl | 7 | benzyl | 1 | 2.9 | 727 |
| 102 | acetyl | 6 | benzyl | 2 | 4.4 | 775 |
| 103 | acetyl | 7 | benzoyl | 1 | 3.0 | 741 |
| 104 | acetyl | 6 | benzoyl | 2 | 4.5 | 802 |
| 105 | benzyl | 2 | nothing | 0 | 0.6 | 523 |
| 106 | benzyl | 3 | nothing | 0 | 2.5 | 613 |
| 107 | benzyl | 4 | nothing | 0 | 4.3 | 702 |
| 108 | acetyl | 7 | phenylacetyl | 1 | 2.7 | 771 |
| 109 | acetyl | 6 | phenylacetyl | 2 | 4.4 | 847 |

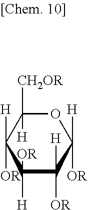

Chem. 11

| | Substituent 1 | | Substituent 2 | | | |
|---|---|---|---|---|---|---|
| | | substi- | | substi- | | |
| Com- | | tution | | tution | | Molecular |
| pound | kind | degree | kind | degree | ClogP | Weight |
| 201 | acetyl | 4 | benzoyl | 1 | 2.2 | 468 |
| 202 | acetyl | 3 | benzoyl | 2 | 3.9 | 514 |
| 203 | acetyl | 2 | benzoyl | 3 | 5.4 | 577 |
| 204 | acetyl | 4 | benzyl | 1 | 2.1 | 454 |
| 205 | acetyl | 3 | benzyl | 2 | 3.8 | 489 |
| 206 | acetyl | 2 | benzyl | 3 | 5.4 | 535 |
| 207 | acetyl | 4 | phe- | 1 | 2.2 | 466 |
| | | | nylacetyl | | | |
| 208 | acetyl | 3 | phe- | 2 | 3.8 | 543 |
| | | | nylacetyl | | | |
| 209 | acetyl | 2 | phe- | 3 | 5.5 | 619 |
| | | | nylacetyl | | | |
| 210 | phe- | 1 | nothing | 0 | −0.3 | 298 |
| | nylacetyl | | | | | |
| 211 | phe- | 2 | nothing | 0 | 2.0 | 416 |
| | nylacetyl | | | | | |
| 212 | phe- | 3 | nothing | 0 | 3.8 | 535 |
| | nylacetyl | | | | | |
| 213 | phe- | 4 | nothing | 0 | 6.2 | 654 |
| | nylacetyl | | | | | |

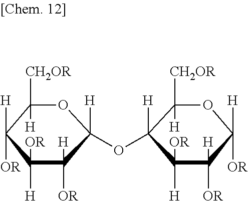

Chem. 13

| | Substituent 1 | | Substituent 2 | | | |
|---|---|---|---|---|---|---|
| | | substi- | | substi- | | |
| Com- | | tution | | tution | | Molecular |
| pound | kind | degree | kind | degree | ClogP | Weight |
| 301 | acetyl | 6 | benzoyl | 2 | 4.5 | 803 |
| 302 | acetyl | 6 | benzyl | 2 | 4.2 | 775 |
| 303 | acetyl | 6 | phe- | 2 | 4.3 | 831 |
| | | | nylacetyl | | | |
| 304 | benzoyl | 2 | nothing | 0 | 0.2 | 551 |
| 305 | benzyl | 2 | nothing | 0 | 0.0 | 522 |
| 306 | phe- | 2 | nothing | 0 | 0.0 | 579 |
| | nylacetyl | | | | | |

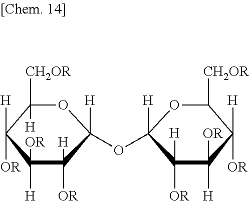

Chem. 15

| | Substituent 1 | | Substituent 2 | | | |
|---|---|---|---|---|---|---|
| | | substi- | | substi- | | |
| Com- | | tution | | tution | | Molecular |
| pound | kind | degree | kind | degree | ClogP | Weight |
| 401 | acetyl | 6 | benzoyl | 2 | 4.5 | 803 |
| 402 | acetyl | 6 | benzyl | 2 | 4.2 | 775 |
| 403 | acetyl | 6 | phe- | 2 | 4.3 | 831 |
| | | | nylacetyl | | | |
| 404 | benzoyl | 2 | nothing | 0 | 0.7 | 551 |
| 405 | benzyl | 2 | nothing | 0 | 0.4 | 523 |
| 406 | phe- | 2 | nothing | 0 | 0.5 | 579 |
| | nylacetyl | | | | | |

It is appropriate that the sugar ester compound be incorporated in an amount of 2 to 30 parts by mass, preferably 5 to 20 parts by mass, with respect to 100 parts by mass of cellulose acylate.

When a polyester plasticizer is used in combination with the sugar ester compound, it is appropriate that the addition amount (parts by mass) of the sugar ester compound be from 0.5 to 10 times (by mass ratio), preferably from 0.5 to 8 times (by mass ratio), larger than that of the polyester plasticizer.

### [Retardation Raising Agent]

To the present cellolose acylate film, a retardation raising agent may be added in response to the intended retardation. When an additive capable of raising the retardation in the film thickness direction (Rth) in particular is incorporated into a cellulose acylate film, the cellulose acylate film can have a raised Rth, and a polarizing plate containing such a cellulose acylate film allows extension of viewing angles of a liquid crystal display device.

The retardation raising agent has no particular restrictions, but the compounds represented by the following Formula (I) are especially preferred.

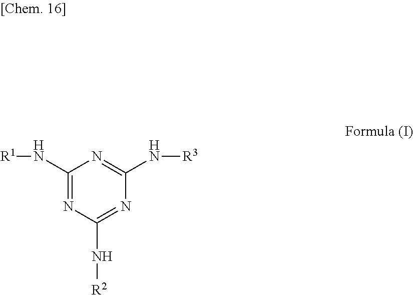

In Formula (I), R¹, R² and R³ are independent of one another and each represents an alkyl group, an alkenyl group, an aromatic ring group or a heterocyclic ring group. The alkyl group, the alkenyl group, the aromatic ring group or the heterocyclic ring group may further have a substituent.

To begin with, compounds represented by Formula (I) are illustrated in detail.

Although R¹, R² and R³ are independent of one another and each represents an alkyl group, an alkenyl group, an aromatic ring group or a heterocyclic ring group, the aromatic ring group or the heterocyclic ring group is preferable to the others. The aromatic ring group each of R¹, R² and R³ can represent is preferably an aryl group having a carbon number of 6 to 20, far preferably an aryl group having a carbon number of 6 to 10, further preferably a phenyl group or a naphthyl group, particularly preferably a phenyl group.

Each of R¹, R² and R³ may further have a substituent. Examples of such a substituent include a halogen atom, a hydroxyl group, a cyano group, a nitro group, a carboxyl group, an alkyl group, an alkenyl group, an aryl group, an alkoxy group, an alkenyloxy group, an aryloxy group, an acyloxy group, an alkoxycarbonyl group, an alkenyloxycarbonyl group, an aryloxycarbonyl group, a sulfamoyl group, an alkyl-substituted sulfamoyl group, an alkenyl-substituted sulfamoyl group, an aryl-substituted sulfamoyl group, a sulfonamide group, a carbamoyl group, an alkyl-substituted carbamoyl group, an alkenyl-substituted carbamoyl group, an aryl-substituted carbamoyl group, an amido group, an alkylthio group, an alkenylthio group, an arylthio group and an acyl group.

When R¹, R² and R³ represent heterocyclic ring groups, it is preferred that the heterocyclic rings have aromaticity. Heterocyclic rings having aromaticity are generally unsaturated heterocyclic rings, preferably heterocyclic rings each having the greatest possible numbers of double bonds. The heterocyclic rings are preferably 5-membered, 6-membered or 7-membered rings, far preferably 5-membered or 6-membered rings, particularly preferably 6-membered rings. Hetero atoms of heterocyclic rings are preferably nitrogen, sulfur or oxygen atoms, particularly preferably nitrogen atoms. Among heterocyclic rings having aromaticity, pyridine rings (2-pyridyl and 4-pyridyl groups as heterocyclic ring groups) are preferred over the others. The heterocyclic ring groups may have substituents. Examples of the substituents the heterocyclic ring groups may have include the same ones as the examples of substituents recited above. These substituents may further have substituents as recited above.

Suitable examples of a compound represented by Formula (I) are illustrated below, but the compound should not be construed as being limited to these examples.

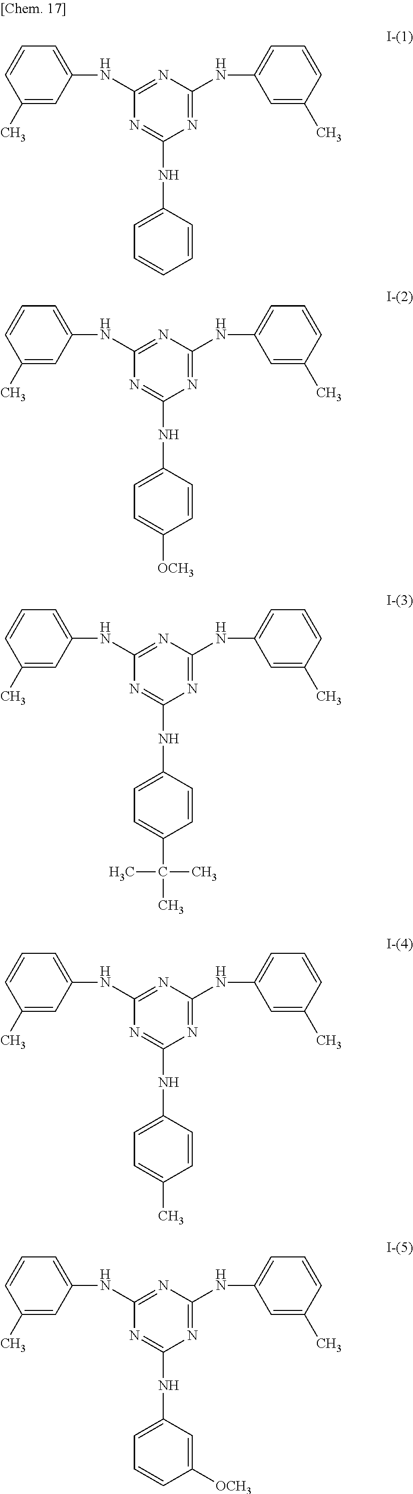 [SMILES: Cc1cccc(Nc2nc(Nc3ccccc3)nc(Nc3cccc(C)c3)n2)c1 ; COc1ccc(Nc2nc(Nc3cccc(C)c3)nc(Nc3cccc(C)c3)n2)cc1 ; Cc1cccc(Nc2nc(Nc3ccc(C(C)(C)C)cc3)nc(Nc3cccc(C)c3)n2)c1 ; Cc1ccc(Nc2nc(Nc3cccc(C)c3)nc(Nc3cccc(C)c3)n2)cc1 ; COc1cccc(Nc2nc(Nc3cccc(C)c3)nc(Nc3cccc(C)c3)n2)c1]

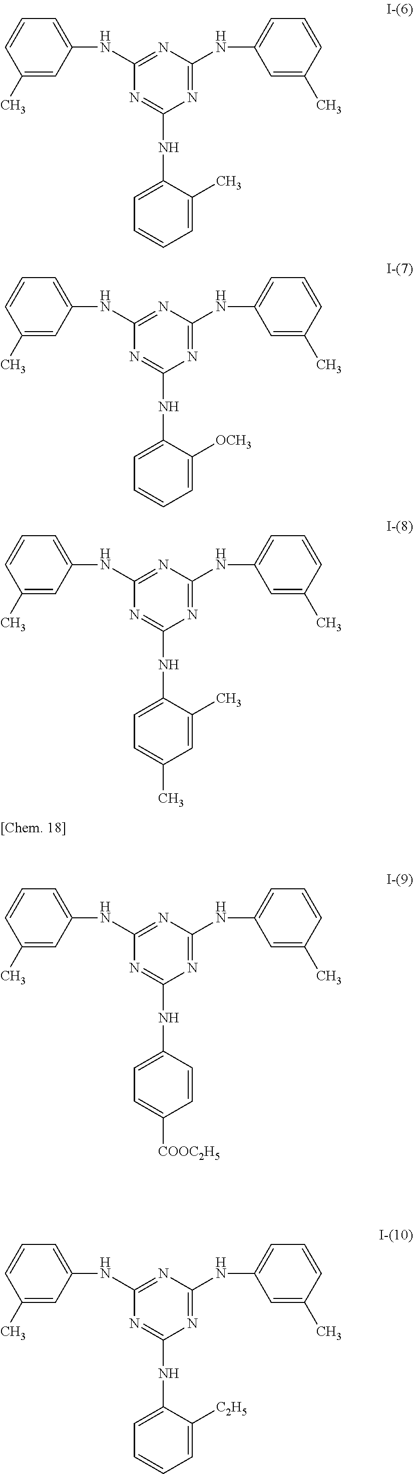

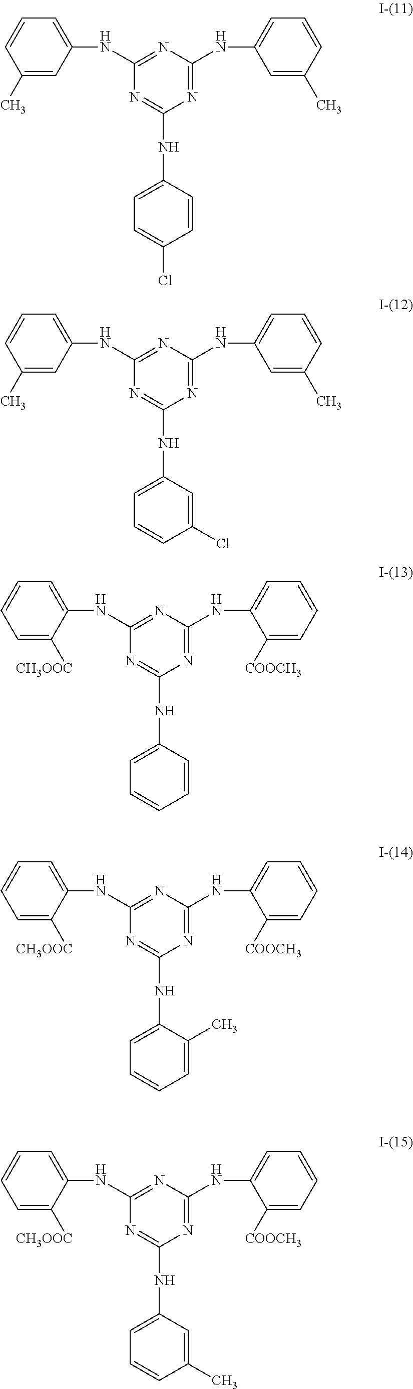

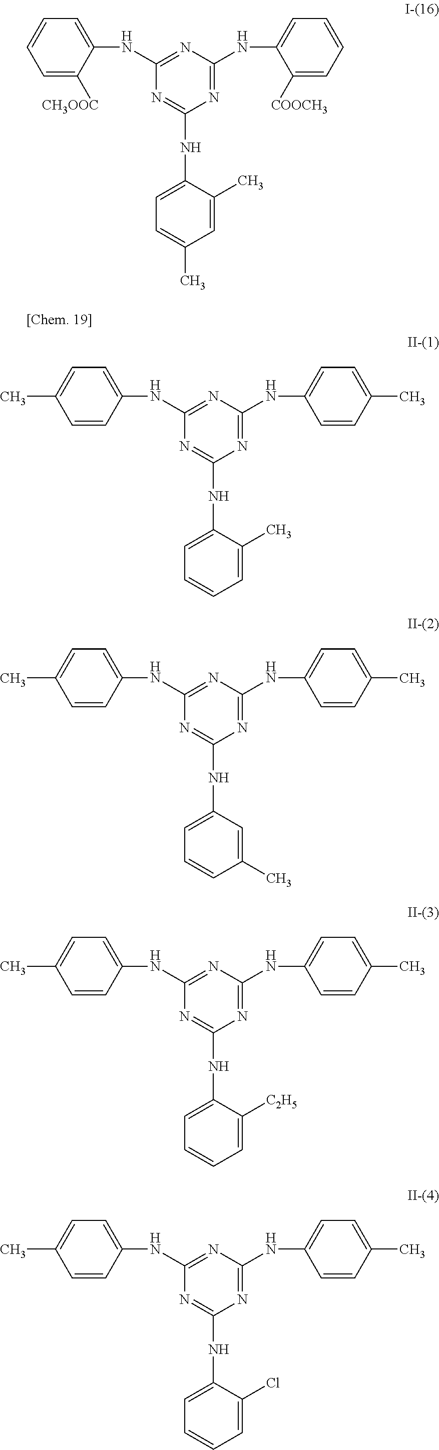

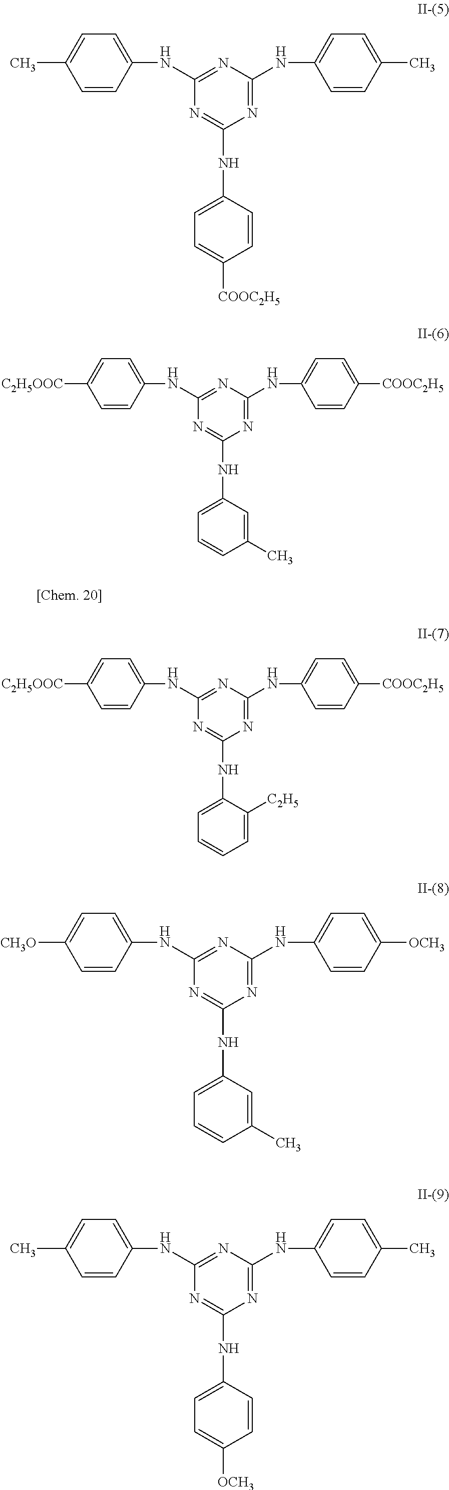

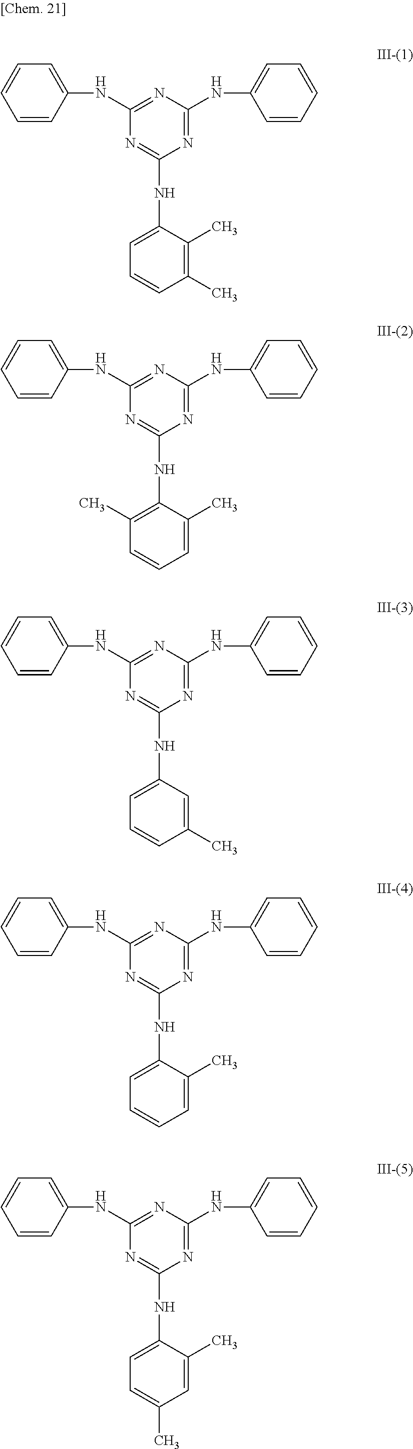 [SMILES: Cc1cccc(Nc2nc(Nc3ccccc3)nc(Nc3ccccc3)n2)c1C ; Cc1cccc(C)c1Nc1nc(Nc2ccccc2)nc(Nc2ccccc2)n1 ; Cc1cccc(Nc2nc(Nc3ccccc3)nc(Nc3ccccc3)n2)c1 ; Cc1ccccc1Nc1nc(Nc2ccccc2)nc(Nc2ccccc2)n1 ; Cc1ccc(Nc2nc(Nc3ccccc3)nc(Nc3ccccc3)n2)c(C)c1]

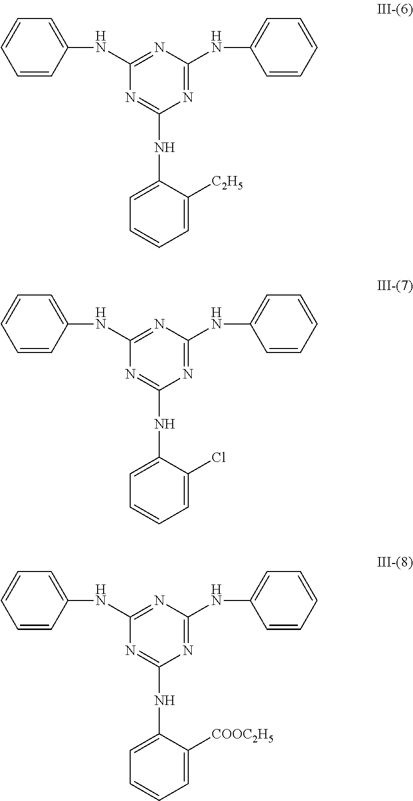

### [Retardation]

As to the present cellulose acylate film, its Re and Rth (defined by the following expressions (I) and (II), respectively) measured at a wavelength of 590 nm can be adjusted as appropriate according to uses thereof, and these values can be controlled through the selections of the kind of substituent and substitution degree of cellulose acylate, the kinds and addition amounts of additives, film thickness, conditions in film forming and stretching processes, and so on.

Re=(nx−ny)×d(nm) Expression (I)

Rth={(nx+ny)/2−nz}×d(nm) Expression (II)

In the expressions, nx is a refractive index in the direction of a slow axis in a film plane, ny is a refractive index in the direction of a fast axis in a film plane, nz is a refractive index in the direction of film thickness, and d is a film thickness (nm).

In this case, the direction of a slow axis in a film plane is not particularly restricted, but it is preferably nearly parallel or nearly orthogonal to the direction in which the in-plane elasticity modulus of a film becomes the maximum.

Re and Rth can be measured as follows.

Re and Rth (unit: nm) in this description are values determined according to the following method. To begin with, a film is subjected to humidity conditioning at a temperature of 25° C. and a relative humidity of 60% for 24 hours. Then the film is irradiated with a 532-nm solid laser by using a prism coupler (MODEL2010 Prism Coupler, made by Metricon Corporation) at a temperature of 25° C. and relative humidity of 60% and thereby an average refractive index (n) is determined.

n=(n_{TE}×2+n_{TM})/3 Expression (2)

In the above expression, n_{TE} is a refractive index measured with polarized light in the plane direction of the film, and n_{TM} is a refractive index measured with polarized light in the direction of normal to the film plane.

In this description, Re (λnm) and Rth (λnm) represent in-plane retardation and retardation in a thickness direction at a wavelength of λ (unit: nm), respectively. Re (λnm) is measured through the exposure of a film surface to light of a wavelength of λnm incident from the direction of normal to the film surface in KOBRA 21ADH or WR (made by Oji Scientific Instruments).

When the film to be measured is described as a uniaxial or biaxial refractive index ellipsoid, Rth (λnm) is calculated by the following method.

Rth (λnm) is determined by measuring a total 6 values of Re (λnm) on conditions that a film surface is exposed to light of a wavelength of λnm incident from each of six directions tilting in 10-degree increments from the direction of normal to the film surface in a range from the film's normal line to 50 degrees on one side with the in-plane slow axis (decided by KOBRA21ADH or WR) being taken as the tilt axis (the rotation axis) (when there is no slow axis, with an arbitrary direction in a film plane being taken as the rotation axis), and getting KOBRA 21ADH or WR to calculate on the basis of the measured retardation values, the average refractive index and the input thickness value.

The above retardation values simply expressed as Re and Rth without a special mention of λ represent the values measured using light of a wavelength of 590 nm. In the case of a film having a direction in which the retardation value become zero at some tilt angle when the direction of incident light is tilted from the normal line with the in-plane slow axis being taken as the rotation axis, the retardation values at tilt angles greater than such a tilt angle are changed to minus in sign and entered into KOBRA 21ADH or WR at the time of calculation.

Alternatively, Rth can also be calculated by measuring retardation values from the two directions tilting arbitrarily with the slow axis being taken as the tilt axis (the rotation axis) (when there is no slow axis, with an arbitrary direction in a film plane being taken as the rotation axis), and calculating based on the measured values, an average refractive index and the input thickness value according to the following mathematical expressions (3) and (4).

$$Re ( θ ) = [ nx - \frac{( ny \times nz )}{( \sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad Expression ( 3 )$$

In the above expression, Re(θ) represents a retardation value in a direction tilting a degree θ from the normal-line direction. And nx represents a refractive index in the direction of the slow axis in a film plane, ny represents a refractive index in the direction orthogonal to nx in the film plane, nz represents a refractive index in the thickness direction orthogonal to both nx and ny, and d represents a film thickness.

Rth=((nx+ny)/2−nz)×d Expression (4):

In the case of a film which cannot be described as a uniaxial or biaxial refractive index ellipsoid, or a film devoid of the so-called optical axis, Rth (λnm) is calculated by the following method.

Rth (λnm) is determined by measuring a total 11 values of Re (λnm) on conditions that a film surface is exposed to light of a wavelength of λnm incident from each of 11 directions tilting in 10-degree increments in a range from −50 degrees to +50 degrees with respect to the direction of normal to the film surface with the in-plane slow axis (decided by KOBRA21ADH or WR) being taken as the tilt axis (the rotation axis), and getting KOBRA 21ADH or WR to calculate on the basis of the measured retardation values, the average refractive index and the input thickness value. By inputting these average refractive index and film thickness, KOBRA 21ADH or WR calculates nx, ny and nz. By the use of these calculated nx, ny and nz values, Nz=(nx−nz)/(nx−ny) is further calculated.

In addition, it is also possible in the above measurements to utilize as average refractive indexes the values published in Polymer Handbook (JOHN WILEY & SONS, INC.) and catalogs of various types of optical films. In cases where the average refractive indexes of films to be examined are publicly unknown, the values thereof can be measured according to the foregoing methods. The values of average refractive indexes of main optical films are enumerated below: Cellulose acylate (1.48), cycloolefin polymer (1.52), polycarbonate (1.59), polymethyl methacrylate (1.49) and polystyrene (1.59).

### [Particulate Substance as Matting Agent]

It is appropriate that a particulate substance as matting agent be added to the present cellulose acylate film. Examples of the particulate substance as matting agent include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. As the particulate substance, silicon-containing compounds, especially silicon dioxide, are preferable to the others from the viewpoint of reducing turbidity. It is appropriate that the silicon dioxide particulate be 20 nm or smaller in average size of primary particles and 70 g/L or higher in apparent density. Primary particles having a smaller average size of 5 to 16 nm are preferred because they can contribute to reduction in haze of the film. The apparent density is preferably in a range of 90 to 200 g/L and beyond, far preferably in a range of 100 to 200 g/L and beyond. Higher apparent density is preferred because it allows the easier preparation of dispersion high in concentration and the greater improvements in haze and aggregate.

These fine particles form secondary particles having an average particle size of 0.1 to 3.0 μm, and they are generally present in the film in the form of secondary particles as an aggregate of primary particles and contribute to formation of an uneven film surface. The unevenness at the film surface is of the order of 0.1 to 3.0 μm. The average size of secondary particles is preferably from 0.2 to 1.5 μm, far preferably from 0.4 to 1.2 μm, particularly preferably from 0.6 to 1.1 μm. As to the size of a primary particle and that of a secondary particle, particles in the film are observed under a scanning electron microscope, and the diameter of a circle circumscribing a particle is defined as a size of the particle. In addition, 200 particles are observed in different spots, and the average value of diameters of these particles is defined as an average particle size.

As the silicon dioxide particulate can be used available products, such as Aerosil R972, R972V, R974, R812, 200, 200V, 300, 8202, OX50 and TT600 (produced by Nippon Aerosil Co., Ltd.). The zirconium oxide particulate is commercially available as products having trade names of e.g. Aerosil R976 and R811 (produced by Nippon Aerosil Co., Ltd.), and these products can be used.

Of those products, Aerosil 200V and Aerosil R972V are preferred over the others because they are silicon dioxide particulate products having average particle sizes of 20 nm or smaller and apparent densities of 70 g/L or higher, and besides, they are highly effective in lowering a friction coefficient while keeping the turbidity of optical films low.

In preparing a dispersion of fine particles in order to obtain an optical film containing secondary particles having a small average particle size in the invention, some usable methodologies can be conceived. For example, there is a method of preparing in advance a dispersion of fine particles by mixing a solvent and fine particles with stirring, adding this dispersion of fine particles to a small amount of solution prepared separately and dissolving the dispersion in the solution with stirring, and further mixing the resultant solution with a main dope solution. This method is a favorable method in terms of ensuring good dispersibility and resistance to re-aggregation of silicon oxide particles. In addition, there is also a method of adding a small amount of cellulose acylate to a solvent and dissolving the cellulose acylate in the solvent with stirring, adding fine particles to the resultant solution and dispersing the fine particles by means of a dispersing machine to prepare a particle-added solution, and thoroughly mixing the particle-added solution with a dope solution by means of an in-line mixer. The invention is not limited to these methods, and it is appropriate that the silicon dioxide concentration at the time of mixing silicon dioxide particles with a solvent and dispersing the particles into the solvent be from 5 to 30 mass %, preferably from 10 to 25 mass %, particularly preferably from 15 to 20 mass %. Dispersions higher in concentration are preferable because the solution turbidity with respect to the amount added becomes lower and improvements in haze and aggregate becomes the greater.

It is preferred that a matting agent be incorporated in the final dope solution in the largest possible amount within the allowable range of film haze in the case of a soft, additive-rich film like the present film, and the amount incorporated is preferably from 0.01 to 1.0 g/m², far preferably from 0.03 to 0.3 g/m², particularly preferably from 0.08 to 0.16 g/m². When the cellulose acylate film is formed so as to have a multilayer structure according to such a film making method as co-casting, it is appropriate that a matting agent shouldn't be added to inner layers but it be added only to the surface layer side. In this case, the suitable amount of a matting agent added to the surface layer is from 0.001 mass % to 0.2 mass %, preferably from 0.01 mass % to 0.1 mass %.

The solvent used in forming the dispersion is preferably a lower alcohol, with examples including methyl alcohol, ethyl alcohol, propyl alcohol, isopropyl alcohol and butyl alcohol. There is no particular restriction as to solvents other than a lower alcohol, but it is appropriate that they be solvents to be used in forming the cellulose acylate film.

### [Other Additives]

A wide kind of additives (e.g. a plasticizer, an ultraviolet absorbent, a deterioration inhibitor, a release agent, an infrared absorbent, a wavelength dispersion control agent) can be incorporated into the cellulose acylate film. They may be in a state of solid or in a state of oil. In other words, there are no particular limits to their melting temperatures and boiling temperatures. For example, a mixture of ultraviolet absorbents having melting temperatures above and below 20° C., respectively, and a mixture of plasticizers differing similarly to the above may be incorporated. An example of such a case can be found in e.g. JP-A-2001-151901. As to addition of a mixture of infrared absorbents, an example thereof can be found in e.g. JP-A-2001-194522. Further, the addition timing of additives may be at any stage in a dope preparation process, or addition of additives may be carried out in a supplemental step provided after the final step of a dope preparation process, thereby completing the preparation of the dope. The addition amount of each ingredient is not particularly limited so long as the function thereof develops. When the cellulose acylate film is formed of many layers, each layer may differ from every other layer in addition amounts and kinds of additives. These things are previously known arts as disclosed in e.g. JP-A-2001-151902. Where further information about these arts is concerned, it is advantageous for the invention to use the ingredients described in Hatsumei Kyokai Kokai Giho, Kogi No. 2001-1745, pp. 16-22, published by Hatsumei Kyokai on Mar. 15, 2001.

### [Amount of Additive Incorporated]

In the cellulose acylate film of the present invention, in the case that those other additives are added therein, the suitable total amount of additives added is from 30 to 200 mass %, preferably from 40 to 180 mass %, far preferably from 45 to 150 mass %, with respect to cellulose acylate.

### [Method of Making Cellulose Acylate Film]

### (Organic Solvent for Dope Solution)

In the invention, it is preferred that the film containing a cellulose acylate be made through the use of a solvent cast method, and the film is made with a dope, or a solution prepared by dissolving polymers including a cellulose acylate in an organic solvent. An organic solvent suitable for use as a main solvent in the invention has no particular restrictions so long as polymers can be dissolved in it, but it is preferably a solvent selected from esters, ketones or ethers having carbon numbers in a range of 3 to 12, or halogenated hydrocarbons having carbon numbers in a range of 1 to 7. The esters, the ketones and the ethers may have cyclic structures. A compound having two or more among the ester's, ketone's and ether's functional groups (namely —O—, —CO— and —COO—) can also be used as a main solvent. In addition, those solvents may have other functional groups including an alcoholic hydroxyl group.

For the present cellulose acylate film, a chlorine-type halogenated hydrocarbon may also be used as a main solvent, and a nonchlorine-type solvent, as disclosed in Hatsumei Kyokai Kokai Giho, 2001-1745 (pp. 16-22), may also be used as a main solvent. In other words, there are no particular restrictions on the solvent for the present optical film.

In addition, dope solutions and solvents usable in the present film, including how to dissolve ingredients therein, are disclosed in the following patent documents, and the disclosed matters are all preferred embodiments with the invention. Those are disclosed in e.g. JP-A-2000-95876, JP-A-12-95877, JP-A-10-324774, JP-A-8-152514, JP-A-10-330538, JP-A-9-95538, JP-A-9-95557, JP-A-10-235664, JP-A-12-63534, JP-A-11-21379, JP-A-10-182853, JP-A-10-278056, JP-A-10-279702, JP-A-10-323853, JP-A-10-237186, JP-A-11-60807, JP-A-11-152342, JP-A-11-292988, JP-A-11-60752 and JP-A-11-60752. In these patent documents, there is mention of not only solvents suitable for use in the present cellulose acylate but also physical properties of their solutions and substances capable of being present together in their solutions, and the specifics mentioned therein are also preferred embodiments with the invention.

### (Dissolution Step)

In preparing a dope solution for use in the invention, there is no particular restriction on the method of dissolution. The dissolution may be performed at room temperature, or through the use of a cooling dissolution method or a high-temperature dissolution method, or through the combined use of these methods. To the preparation of a dope solution in the invention and further to steps of concentrating the solution and filtering the solution, it is advantageous to apply the preparation processes described in detail in Hatsumei Kyokai Kokai Giho, Kogi No. 2001-1745, pp. 22-25, published by Hatsumei Kyokai on Mar. 15, 2001.

### (Casting, Drying and Winding Steps)

In the next place, a method of making the present film by the use of a dope solution is described. As a method and facilities for making the present optical film, it is possible to adopt a solution casting film-making method and apparatus for making traditional cellulose acetate film. In one embodiment, a dope solution prepared in a dissolution machine (vessel) is fed from the vessel into a storage tank and once stored therein, foams included in the dope are eliminated, thereby completing the dope preparation, the prepared dope is fed from a dope outlet into a pressure die via e.g. a pressurized-type metering gear pump capable of performing high-accuracy quantitative feed of fluid according to the number of revolutions, and cast uniformly from a mouthpiece (slit) of the pressure die onto a metal support running endlessly in a casting section. Further, at a peel point where the metal support makes an almost complete circuit, a half-dry dope film (referred to as “a web”, too) is peeled away from the metal support, both ends of the web obtained are pinched with clips, the web is conveyed with a tenter while securing its width, and thereby the web is dried. Subsequently thereto, the thus obtained film is released from the clips, conveyed mechanically by means of a group of rolls in a heating apparatus, and wound into a roll of a predetermined length by the use of a winder. The combination of a tenter and a group of rolls in a heating apparatus varies depending on the purpose. As other embodiments, various film making methods utilizing solvent casting can be adopted. For example, it is possible to adopt such a method that a drum cooled to 5° C. or below is used as the metal support, the dope is extruded from the die onto the drum and causes gelling, and the gelled dope is peeled away at the time when it makes a circuit, and conveyed while being stretched with a tenter in pin form and being dried.

The present cellulose acylate film may be stretched in the width direction in a film forming process (specifically in a tenter zone) because it is preferable that the film has some measure of width. On the other hand, for reduction in dimensional change rates of film, it is important not to accumulate residual strains. It is therefore preferred that the web be stretched in the width direction in a state of having residual solvent content of 3 to 250 mass %. By stretching in a state of a very high residual solvent content, crystallization associated with stretching can be inhibited even in a web containing a polymer having a crystallization temperature mentioned below, such as a cellulose acylate, and relaxation of the polymer can be caused by priority. Thus the width can be broadened without accumulating residual strains. The residual solvent content is preferably from 5 to 150 mass %, far preferably from 7 to 100 mass %, further preferably from 10 to 70 mass %. In order to achieve such residual solvent contents, it is effective e.g. to weaken a drying wind, to lower the temperature of a metal support, to pick up a film-forming speed, to increase a film thickness, or to perform co-casting as mentioned below.

In a step after performing stretching in a state of such a high residual solvent content, reduction in relaxation speed of a polymer occurs with a decrease in residual solvent content. In order not to accumulate residual strains, it is therefore important to impose no tension on the web. In this step, it is thus important to reduce the tenter width, and it is appropriate that the width reduction rate be from 0.5% or higher, preferably from 0.7% to 50%, far preferably from 1.0% to 20%, further preferably from 1.5% to 10%, furthermore from 2% to 5%. Too high a width reduction rate causes the web to become wrinkled or to become detached from the tenter, and therefore the preferred width reduction rate is 50% or below.

Alternatively, the following way of thinking can be applied to the method for reducing the tenter width. More specifically, the thinking consists in that reduction of the tenter width can be achieved by controlling the ratio between a width reduction rate of tenter width (Wt) and a free shrinkage rate of web (Ww), namely (Wt/Ww), to within an appropriate range. And this ratio is adjusted so as to fall within a range of 0.7 to 1.3, preferably 0.8 to 1.2, far preferably 0.9 to 1.1, further preferably 0.95 to 1.0. Additionally, the free shrinkage rate of web can be estimated by an off-line experiment (by observing the actual amount of free shrinkage).

Then the web in a state of having a residual solvent content of 0.01 to 30 mass % is preferably heated at a temperature (T1) selected from the range of (Tg−20° C.) to (Tc+20° C.). The temperature (T1) is preferably from (Tg−10° C.) to Tc, far preferably from Tg to (Tc−5° C.), further preferably from (Tg+5° C.) to (Tc−10° C.). In this step, thermal relaxation is promoted by heating to result in reduction of dimensional change rates of film. Too high a heating temperature may, however, result in problems of impairing the effect of improving round unevenness of luminance recognized visually when a liquid crystal display device is observed from slanting directions and causing bleedout of additives in some cases. For this reason, T1 setting is preferably made as the above.

Additionally, in the making of the present cellulose acylate film, casting may be carried out according to a co-casting method for the purpose of controlling the residual solvent content in web. In such a case, it is preferred that casting of two or more layers be performed by extruding two or more dopes differing in solids concentration from a die slit at the same time or one after another. In a specific film making method of extruding a dope onto a cooled metal support, gelling the dope and then peeling away the gelled matter, it is appropriate to heighten a solids concentration in the dope because at least some degree of web strength is necessary. On the other hand, as to the web containing high amounts of additives in particular with the intention of reducing dimensional change rates of film, it is appropriate that the web be conveyed into a tenter in a state of having a higher residual solvent content (a lower solids concentration). As a means of making these situations compatible with each other, it is effective to adopt a method of co-casting layers differing in solids concentration, thereby securing the web strength with a layer of high concentration and the solids concentration with a layer of low concentration. Therein, it is appropriate that the concentration difference between the concentration of a dope solution to form a layer of high solids concentration and the solids concentration of a dope solution to form another layer be at least 1 mass %, preferably from 2 to 20 mass %, far preferably from 3 to 10 mass %. There is no particular restriction on the upper limit of the solids concentration difference, but since there may be cases where film surface conditions deteriorate when the difference becomes greater than 20 mass %, it is preferred that the difference be 20 mass % or below. In addition, it is also appropriate to adjust solids concentrations by controlling individual thicknesses of layers.

Additionally, in carrying out the co-casting, it is possible to adopt a feed block method by which the number of layers can be controlled with ease or a multi-manifold method superior in thickness accuracy of each layer. In the invention, the feed block method can be preferably adopted.

As to the solution casting-utilized film making method applied to the making of functional polarizing plate protective films as optical members of electronic display devices and to the making of silver halide photographic sensitive materials, which are main uses of the present optical film, cases frequently occur in which, in addition to a solution casting-utilized film making apparatus, a coating apparatus is provided for the purpose of giving surface treatment to the film to form e.g. a subbing layer, an antistatic layer, an anti-halation layer and a protective layer. Detailed descriptions of these cases can be found in Hatsumei Kyokai Kokai Giho, Kogi No. 2001-1745, pp. 25-30, published by Hatsumei Kyokai on Mar. 15, 2001. Those descriptions are categorized as casting (including co-casting), metal support, drying, peeling and so on, and they are favorably applicable in the invention.

In the case of forming a film of three-layer structure by superposing a sub-flow on either side of a main flow, the layer formed from the main flow is referred to as an intermediate layer, the layer formed on the support surface side is referred to as a support-sided face, and the face on the opposite side is referred to as an air-sided face.

It is appropriate that the total amount of additives added in each of the layers on the support and air sides be greater than that in the intermediate layer by at least 3 phr, preferably from 3 to 150 phr, far preferably from 3 to 50 phr, particularly preferably from 5 to 30 phr. The suitable thickness of each of the layers on the support and air sides is from 1 to 30 μm, preferably from 3 to 20 μm, far preferably from 5 to 15 μm.

### [Heat Treatment Step]

In the method for making the present cellulose acylate film, the step of further giving heat treatment to the optical film can also be applied as required. At this time, it is appropriate that the treatment be performed at a temperature within the aforementioned temperature constrains. The effects produced in the heat treatment step are not particularly confined, but it is thought that the heat treatment performed at a temperature appropriate to the type of film under control of film tension brings about changes in orientation and crystallization of cellulose acylate molecules present in the film and can change e.g. an expansion coefficient in humid surroundings.

### [Film Thickness]

The suitable thickness of the present cellulose acylate film is from 15 μm to 40 μm, preferably from 20 μm to 35 μm, from the viewpoint of making a film thin.

### [Haze of Film]

Where the haze of the present cellulose acylate film is concerned, the thinner the better, and it is appropriate that the haze value be from 0.01% to 2.0%, preferably 1.0% or below, far preferably 0.5% or below. However, even when the haze value is higher than the suitable range, the haze of the present film has no influences upon display characteristics of the liquid crystal display device because the surface haze component traceable to a surface profile is predominant in the present film's haze and can be eliminated by changing the surface profile, for example, through adhesion to a polarizing film by the use of an adhesive or application of a pressure sensitive adhesive coating. However, unevenness of haze recognized visually between areas on which pressure has already been imposed and hasn't been imposed yet causes a problem of impairing outward appearance of the film for optical film use. It is appropriate that the unevenness of haze rated as the haze distribution of the present film be 0.5% or below, preferably 0.3% or below, far preferably 0.1% or below, further preferably 0.05% or below. The haze measurement can be made by using a present optical film sample measuring 40 mm by 80 mm and a haze meter (HGM-2DR, Suga test instrument) under conditions of 25° C. and 60% RH in accordance with JIS K-6714.

### [Glass Transition Temperature (Tg) and Crystallization Temperature (Tc)]

The term glass transition temperature (Tg) used in the invention refers to the boundary temperature at which movements of polymers constituting the present web or film vary significantly. In the invention, Tg is defined as the temperature at which a base line starts to tilt from the low temperature side when 20 mg of web or film is put in a gastight measuring pan of a differential scanning calorimeter (DSC) and the temperature thereof is raised in a stream of nitrogen from −100° C. to 120° C. at a rate of 10° C./min, and the starting temperature of an exothermic peak observed during the process of further continuing heating until the temperature is raised to 230° C. is defined as Tc.

### [Spectral Characteristic and Spectral Transmittance]

By using an optical film sample measuring 13 mm by 40 mm and a spectrophotometer U-3210 (made by Hitachi Ltd.) under conditions of 25° C. and 60% RH, transmittance in a wavelength range of 300 nm to 450 nm can be measured. It is possible to represent the threshold wavelength by a wavelength of (slope width/2)+5% and the absorption end by a wavelength corresponding to the transmittance of 0.4%. In the foregoing manner, transmittance values at the wavelengths of 380 nm and 350 nm can be evaluated.

In the case of using the present optical film as a protective film of a polarizing plate on the side facing to a liquid crystal cell, it is appropriate that the spectral transmittance of the present film be from 10% to 30% at the wavelength of 380 nm, and that 10% or lower at the wavelength of 350 nm.

### [Moisture Permeability of Film]

The term moisture permeability refers to the weight of water vapor having passed through a sample having an area of 1 m² for 24 hours in an atmosphere having a temperature of 40° C. and a relative humidity of 90%, and the value thereof is determined in conformance with JIS Z0208 Moisture Permeability Testing (cup method).

The suitable moisture permeability of the present film is from 1,000 to 1,700 g/m²·day, especially preferably from 1,050 to 1,400 g/m²·day.

### [Surface Treatment]

By giving surface treatment to cellulose acylate film, improvements in adhesion to optical films and various functional layers (e.g. a subbing layer and a backing layer) can be attained in some instances. Examples of surface treatment usable for such a purpose include glow discharge treatment, ultraviolet irradiation treatment, corona treatment, flame treatment and acid or alkali treatment. Treatment suitable as the glow discharge treatment mentioned above is not only treatment using low-temperature plasma generated under a reduced pressure of 10⁻³ to 20 Torr but also treatment using plasma generated under atmospheric pressure. Gasses capable of plasma excitation refer to the gasses convertible into plasma by pumping under the foregoing conditions, and examples thereof include argon, helium, neon, krypton, xenon, nitrogen, carbon dioxide, CFCs including tetrafluoromethane, and mixtures of any two or more thereof. Details about them are described in Hatsumei Kyokai Kokai Giho, Kogi No. 2001-1745, pp. 30-32, published by Hatsumei Kyokai on Mar. 15, 2001, and can be favorably applied in the invention.

### [Functional Layer]

As to uses for the present cellulose acylate film, those are e.g. optical uses and application to photographic sensitive materials. The optical uses are preferably for incorporation into liquid crystal display devices in particular. Further, it is preferred that each of the liquid crystal display devices be configured so as to include a liquid crystal cell containing a liquid crystal in a state of being supported between two electrode substrates, two polarizing elements placed on both sides of the liquid crystal cell, and at least one optically-compensatory sheet placed between the liquid crystal cell and one of the polarizing elements. The preferred among such liquid crystal display devices are TN, IPS, FLC, AFLC, OCB, STN, ECB, VA AND HAN.

When the present optical film is used for optical purposes, addition of various functional layers is carried out. Examples of such functional layers include an antistatic layer, a cured resin layer (a transparent hard coat layer), an antireflective layer, an ease-of-adhesion layer, an antiglare layer, an optically-compensatory layer, an alignment layer and a liquid crystal layer. These functional layers, including an antistatic layer and a hard coat layer, and materials for them, including a surfactant, a slipping agent and a matting agent, are described in Hatsumei Kyokai Kokai Giho, Kogi No. 2001-1745, pp. 32-45, published by Hatsumei Kyokai on Mar. 15, 2001, and those can be favorably used in the invention.

### <<Retardation Film>>

The present cellulose acylate film can be used as a retardation film. Additionally, the term “a retardation film” signifies an optical material which is generally used in a liquid crystal display device or the like and has optical anisotropy, and is synonymous with a retardation plate, an optically-compensatory film and an optically-compensatory sheet. In a liquid crystal display device, the retardation film is used for the purposes of enhancing screen's contrast and improving viewing angle characteristics and tints.

By using the present optical film, retardation can be controlled with ease, and a retardation film having excellent adhesion to a polarizing film can be made.

In addition, a retardation film having Re and Rth adjusted as appropriate may be made through lamination of two or more sheets of the present optical film or the present optical film and a film other than the present one. The lamination of films can be performed by the use of a pressure-sensitive adhesive or an adhesive.

Further, it is also possible in some instances to use a retardation film made by using the present optical film as a support of the retardation film and providing thereon an optically anisotropic layer including a liquid crystal or the like. The optically anisotropic layer applicable in such a retardation film may be formed from e.g. a composition containing a liquid crystalline compound, or a polymer film having double refraction, or the present optical film.

As the mesomorphic compound, a discotic liquid crystalline compound or a rod-shaped liquid crystalline compound is suitable.

### [Discotic Liquid Crystalline Compound]

Examples of a discotic liquid crystalline compound usable as the foregoing liquid crystalline compound in the invention include the compounds described in a variety of documents, such as C. Destrade et al., Mol. Cryst. Liq. Cryst., Vol. 71, page 111 (1981); The Chemical Society of Japan (editor), Kikan Kagaku Sosetsu (Quarterly Review of Chemistry), No. 22, Ekisho no Kagaku (Chemistsry of Liquid Crystal), Chap. 5 and Section 2 of Chap. 10 (1994); and B. Kohne et al., Angew. Chem. Soc. Chem. Comm., page 1794, (1985); J. Zhang et al., J. Am. Chem. Soc., Vol. 116, page 2655 (1994).

In the optically anisotropic layer, it is preferred that the aligned state of discotic liquid crystalline molecules be fixed, especially by polymerization reaction. As to the polymerization of discotic liquid crystalline molecules, descriptions thereof can be found in JP-A-8-27284. For fixation of discotic liquid crystalline molecules by polymerization, it is required that a polymerizable group be bound as a substituent to a disciform core of each individual discotic liquid crystalline molecules. However, direct bonding of a polymerizable group to the disciform core makes it difficult to keep the aligned state of the molecules in the polymerization reaction. A linkage group is therefore introduced between the polymerizable group and the disciform core. The discotic liquid crystalline molecules having polymerizable groups have been disclosed in JP-A-2001-4387.

### [Rod-Shaped Liquid Crystalline Compound]

Examples of a rod-shaped liquid crystalline compound usable as the foregoing liquid crystalline compound in the invention include azomethine compounds, azoxy compounds, cyanobiphenyl compounds, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyl dioxanes, tolanes and alkenylcyclohexylbenzonitriles. Not only these low-molecular liquid crystalline compounds but also high-molecular liquid crystalline compounds can be used as the rod-shaped liquid crystalline compounds.

In the optically anisotropic layer, it is preferred that the aligned state of rod-shaped liquid crystalline molecules be fixed, especially by polymerization reaction. Examples of a polymerizable rod-shaped liquid crystalline compound usable in the invention include the compounds described e.g. in Macromol. Chem., Vol. 190, p. 2255 (1989); Advanced Materials, Vol. 5, p. 107 (1993); U.S. Pat. Nos. 4,683,327, 5,622,648 and 5,770,107; WO 95/22586 pamphlet, WO 95/24455 pamphlet, WO 97/00600 pamphlet, WO 98/23580 pamphlet and WO 98/52905 pamphlet; and JP-A-1-272551, JP-A-6-16616, JP-A-7-110469, JP-A-11-80081 and JP-A-2001-328973.

### <<Polarizing Plate>>

The present polarizing plate contains at least one sheet of the present optical film or at least one sheet of the present retardation film.

The present optical film or the present retardation film can be used as a protective film of the polarizing plate (the present polarizing plate). The present polarizing plate includes one polarizing film and two polarizing plate protective films (optical films) for protecting both surfaces of the polarizing film, and it is particularly preferred that the present optical film or the present retardation film be used as at least either of the two polarizing plate protective films.

When the present optical film is used as a polarizing plate protective film, it is appropriate that the present optical film be subjected in advance to the surface treatment as mentioned above (as described in JP-A-6-94915 and JP-A-6-118232, too), and thereby be rendered hydrophilic. Examples of the surface treatment favorably given to the present optical film include glow discharge treatment, corona discharge treatment and alkali saponification treatment. Among them, the alkali saponification treatment is used most favorably.

For example, a film prepared by immersing polyvinyl alcohol film in an iodine solution and stretching it can be used as the polarizing film. In the case of using the polarizing film prepared by immersing polyvinyl alcohol film in an iodine solution and stretching it, the surface-treated face of the present optical film is bonded directly to each surface of the polarizing film by the use of an additive. In the present manufacturing method, it is preferred that the optical film, as mentioned above, be stuck directly on the polarizing film. Examples of an adhesive used therein include an aqueous solution of polyvinyl alcohol or polyvinyl acetal (e.g. polyvinyl butyral) and latexes of vinyl polymers (e.g. polybutyl acrylate). Among them, the most suitable adhesive is an aqueous solution of fully saponified polyvinyl alcohol.

In a step for lamination of a polarizing film and an optical film as protective film, the protective film functions so as to inhibit polarizing film' shrinkage attendant on heating. However, when a difference in dimensional change is made between two protective films, curling develops in the polarizing plate. As causes of a difference between dimensional changes, differences in dimensional change rate, elastic modulus and film thickness between the protective films can be adduced. The curling in a direction orthogonal to the conveying direction, in which any tension cannot be applied, becomes an important factor which the workability of the polarizing plate is dependent on. Thus, when the direction in which the elastic modulus becomes maximum in the present optical film is in agreement with the conveying direction, it is appropriate to reduce a dimensional change rate in the direction orthogonal to that direction; while, when the direction in which the elastic modulus becomes maximum in the present optical film is orthogonal to the conveying direction, it is appropriate to reduce a dimensional change rate in that direction. Alternatively, it is also effective as the method of reducing the curling by controlling polarizing film's shrinkage in itself to lower the heating temperature in the drying zone after lamination step for the polarizing plate.

In general a liquid crystal display device contains a liquid crystal cell provided between two polarizing plates, and hence the device has 4 sheets of polarizing plate protective films. The present optical film may be used as any one among the 4 polarizing plate protective films, but it is particularly advantageous to use the present optical film as a protective film to be placed between each polarizing film and the liquid crystal layer (liquid crystal cell) in a liquid crystal display device. And as a protective film to be placed on the side opposite to the present optical film across the polarizing film, a transparent hard coat layer, an antiglare layer, an antireflective layer and so on can be provided, and such a layer is preferably used as the polarizing plate protective film to be placed at the outermost surface on the display side, in particular, of a liquid crystal display device.

A polarizing plate includes a polarizer and protective films for protecting both surfaces of the polarizer, and further on one surface thereof is stuck a film for protection use and on the other surface of the polarizing plate is stuck a film for separation use, and thereby the polarizing plate is prepared as a product. The film for protection use and the film for separation use are provided for the purpose of protecting the polarizing plate at the time of shipment and during inspection of the product. Therein, the film for protection use is provided for protection of a polarizing plate surface, and applied to the polarizing plate surface situated on the side opposite to the polarizing plate surface on which a liquid crystal plate is to be stuck. And the film for separation use is provided for the purpose of covering an adhesive layer for sticking the polarizing plate on a liquid crystal plate, and applied to the polarizing plate surface situated on the side where the polarizing plate is to be stuck on the liquid crystal plate.

In a liquid crystal display device, substrates holding a liquid crystal are generally placed between two polarizing plates, and the polarizing plate protective film to which the present optical film is applied can deliver excellent display performance even when it is placed at any site. As the polarizing plate protective film situated at the outermost surface on the display side, in particular, of a liquid crystal display device, a transparent hard coat layer, an antiglare layer, an antireflective layer or the like is provided. It is therefore appropriate that the present polarizing plate protective film be used at such a site in particular.

### <<Liquid Crystal Display Device>>

The present cellulose acylate film and the present polarizing plate can be incorporated into liquid crystal display devices various in display mode. Various liquid crystal modes in which the present film and plate are usable are explained below. In all of these modes, the present optical film, retardation film and polarizing plate can be favorably used, and they can preferably used in VA-mode and IPS-mode liquid crystal display devices in particular. These liquid crystal display devices may be any of transmissive, reflective and transflective types.

### (TN Liquid Crystal Display Device)

The present optical film is favorably used as the substrate of a retardation film incorporated into a TN liquid crystal display device having a TN-mode liquid crystal cell. About TN-mode liquid crystal cells and TN liquid crystal display devices, there have been well known for a long time. Descriptions of retardation films for use in TN liquid crystal display devices can be found e.g. in JP-A-3-9325, JP-A-6-148429, JP-A-8-50206, JP-A-9-26572, and papers by Mori et al. (Jpn. J. Appl. Phys., Vil. 36, p. 143 (1997) and Jpn. J. Appl. Phys., Vol. 36, p. 1068 (1997)). In those embodiments each, the polarizing plate using the present optical film can contribute to an increase in viewing angel and an improvement in contrast. From the viewpoint of a viewing angle increase in particular, it is preferred that Rth at the wavelength of 590 nm be greater than 10 nm, and moreover it is especially preferred that Rth in a range of 450 nm to 650 nm be 25 nm or greater.

### (STN Liquid Crystal Display Device)

The present optical film may also used as the substrate of a retardation film incorporated into a STN liquid crystal display device having a STN-mode liquid crystal cell. In STN liquid crystal display devices each, rod-shaped liquid crystalline molecules in the liquid crystal cell are generally twisted in a twist angle range of 90° to 360°, and the product of a refractive index anisotropy (Δn) of rod-shaped liquid crystalline molecules and a cell gap (d), Δn·d, is in a range of 300 nm to 1,500 nm. Descriptions of retardation films for use in STN liquid crystal display devices can be found in JP-A-2000-105316.

### (VA Liquid Crystal Display Device)

The present optical film is used with particular advantage as a retardation film or the substrate of a retardation film incorporated into a VA liquid crystal display device having a VA-mode liquid crystal cell. In the VA liquid crystal display device, there's nothing wrong with adopting the multi-domain alignment mode as disclosed e.g. in JP-A-10-123576. In those embodiments, the polarizing plate using the present optical film can contribute to an increase in viewing angle and an improvement in contrast.

### (IPS Liquid Crystal Display Device and ECB Liquid Crystal Display Device)

The present optical film is used with particular advantage as a retardation film, the substrate of a retardation film or a polarizing plate protective film incorporated into an IPS liquid crystal display device having an IPS-mode liquid crystal cell or an ECB liquid crystal display device having an ECB-mode liquid crystal cell. These modes are embodiments in which a liquid crystalline substance is in nearly parallel orientation at the time of black display, and the black display is produced by aligning liquid crystal molecules in parallel with the substrate surface under no applied voltage. In these embodiments, the polarizing plate using the present optical film can contribute to an increase in viewing angle and an improvement in contrast.

In addition, |Rth|<25 is preferable, and moreover Rth≦0 nm in a wavelength range of 450 nm to 650 nm is especially preferred in point of a small change in tint.

In such embodiments, it is appropriate to provide, on the top and bottom of a liquid crystal cell, polarizing plates each of which uses the present optical film as a protective film which is one of the protective films in polarizing plates provided on the top and bottom of the liquid crystal cell and is situated between the liquid crystal cell and each of the polarizing plates (a cell-side protective film). In addition, it is far preferred that an optically anisotropic layer whose retardation value is adjusted to be twice the Δn·d value or less be provided on one side of a liquid crystal cell, and that between the protective film of the polarizing plate and the liquid crystal cell.

### (OCB Liquid Crystal Display Device and HAN Liquid Crystal Display Device)

The present optical film is used with advantage as the substrate of a retardation film incorporated into an OCB liquid crystal display device having an OCB-mode liquid crystal cell or an HAN liquid crystal display device having a HAN-mode liquid crystal cell. As to the retardation film incorporated into an OCB liquid crystal display device or an HAN liquid crystal display device, it is appropriate that the direction in which the absolute value of retardation becomes a minimum be absent both in the plane of the retardation film and in the direction of the normal thereto. Optical properties of the retardation film incorporated into an OCB liquid crystal display device or an HAN liquid crystal display device are also determined by optical properties of an optically anisotropic layer, optical properties of a substrate and positioning of the optically anisotropic layer and the substrate. Descriptions of retardation films for use in OCB liquid crystal display devices and HAN liquid crystal display devices can be found in JP-A-9-197397. In addition, those can also be found in a paper by Mori et al. (Jpn. J. Appl. Phys., Vol. 38, p. 2837 (1999)).

### (Reflective Liquid Crystal Display Device)

The present optical film is also used with advantage as a retardation film incorporated into a reflective liquid crystal display device of TN, STN, HAN or GH (Guest-Host) type. These display modes have been well-known for a long time. As to reflective liquid crystal display devices of TN type, descriptions thereof can be found in JP-A-10-123478, WO 98/48320 pamphlet and Japanese Patent No. 3022477. As to retardation films incorporated into reflective liquid crystal display devices, descriptions thereof can be found in WO 00/65384 pamphlet.

### (Other Liquid Crystal Display Devices)

The present optical film is also used with advantage as the substrate of a retardation film incorporated into an ASM (Axially Symmetric Aligned Microcell) liquid crystal display device having an ASM-mode liquid crystal cell. The ASM-mode liquid crystal cell has a feature that the cell thickness is maintained by means of a position-controllable resin spacer, and other properties thereof are the same as in the case of TN-mode liquid crystal cells. As to ASM-mode liquid crystal cells and ASM liquid crystal display devices, descriptions thereof can be found in a paper by Kume et al., SID 98 Digest, p. 1089 (1998).

Further, the present optical film can also be used as a retardation film or the substrate of a retardation film favorably used in a graphic display panel capable of producing 3D stereoscopic image display. More specifically, there may be two cases where a λ/4 layer is formed all over the surface of the present optical film and a retardation layer patterned e.g. with alternately-aligned lines which differ in birefringence is formed all over the surface of the present optical film. The present optical film is small in dimensional change rate on humidity change as compared with traditional cellulose acylate films, and can therefore be favorably used in the latter case in particular.

### (Hard Coat Film, Antiglare Film and Antireflective Film)

The present optical film is applicable to a hard coat film, an antiglare film and an antireflective film. For the purpose of improving visibility of a flat panel display, such as LCD, PDP, CRT or EL, any or all of hard coat, antiglare and antireflective layers can be added on one or each of the present optical film surfaces. Desirable embodiments of antiglare layers and antireflective layers are described in detail in Hatsumei Kyokai Kokai Giho, Kogi No. 2001-1745, pp. 54-57, published by Hatsumei Kyokai on Mar. 15, 2001, and therein the present optical film can be favorably used.

### EXAMPLES

Features of the invention will now be illustrated more specifically by reference to the following Examples. It will be apparent to persons skilled in the art that various changes and modifications can be made as appropriate as to the materials, the amounts and proportions of ingredients used, the treatment specifics and procedures, and so on without departing from the spirit and scope of the invention. Therefore the scope of the invention should not be construed as being limited to Examples illustrated below.

### (Preparation of Cellulose Acylate Dope)

Each of the compositions given in the following Table 1 was charged into a mixing tank and stirred, and thereby the ingredients in each composition were dissolved in a solvent to prepare a cellulose acetate solution. Additionally, the solvent used in each solution had the following composition, and the cellulose acetate solution was adjusted to have a cellulose acetate concentration of 17 mass %. Thus a cellulose acylate dope was prepared.

In Table 1, all of addition amounts of a plasticizer, an ultraviolet absorbent (1), an ultraviolet absorbent (2) and an Rth raising agent are expressed in parts by mass with respect to 100 parts by mass of cellulose acetate.

| | |
|---|---|
| Methylene chloride (first solvent) | 92 parts by mass |
| Methanol (second solvent) | 8 parts by mass |

Further, the following matting agent dispersion was added in an amount of 3.6 parts by mass to 100 parts by mass of the cellulose acylate dope.

### (Matting Agent Dispersion)

| | |
|---|---|
| Particulate silica dispersion (average particle size: | 0.7 parts by mass |
| 16 nm) | |
| Methylene chloride (first solvent) | 75.5 parts by mass |
| Methanol (second solvent) | 6.5 parts by mass |
| Dope prepared in the above manner | 17.3 parts by mass |

### (Making of Cellulose Acylate Film)

The cellulose acylate dope was cast from an outlet of a casting die onto a 20° C. drum. The thus formed film was peeled away from the drum in a state of having a solvent content of about 20 mass %, and dried as both ends of the film in the width direction were fixed with tenter clips. Thereafter, the thus dried film was further dried by being conveyed while being passed between rolls in a heat treatment apparatus. Thus a cellulose acylate film having a thickness given in Table 1 was made.

Samples 19 and 25 as Comparative Examples were heavy in environmental load because of using a chlorine-containing ultraviolet absorbent UV-4.

### [Table 1]

TABLE 1

| | Degree | | | | | | | | | | | | | | |
|---|---|---|---|---|---|---|---|---|---|---|---|---|---|---|---|
| | of | | | | | | | | | | | | | | |
| | acetyl | | | | | | | | | | | | | | |
| | substi- | | | | | | | | | | | | | | |
| | tution | | | | | | | Rth | | | Whiten- | | | Durability | |
| | in | | | Ultraviolet | | Ultraviolet | | raising agent | | Film | ing | Moisture | | under | |
| | cellu- | Plasticizer | | absorbent (1) | | absorbent (2) | | (3) | | thick- | by | perme- | | humid | |
| | lose | | amount | | amount | | amount | | amount | ness | saponi- | ability | Rth | and hot | |
| # | acylate | kind | added | kind | added | kind | added | kind | added | (μm) | fication | g/m²•day | (nm) | conditions | Remark |
| 1 | 2.88 | P-1 | 12 | UV-1 | 1.8 | UV-2 | 0.8 | — | — | 25 | A | 1240 | 19 | A | Example |
| 2 | 2.88 | P-1 | 12 | UV-1 | 1.3 | UV-2 | 1.3 | — | — | 25 | A | 1240 | 18 | A | Example |
| 3 | 2.88 | P-1 | 12 | UV-1 | 0.8 | UV-2 | 1.8 | — | — | 25 | A | 1240 | 17 | A | Example |
| 4 | 2.88 | P-2 | 12 | UV-1 | 1.8 | UV-2 | 0.8 | — | — | 25 | A | 1240 | 19 | A | Example |
| 5 | 2.88 | P-4 | 12 | UV-1 | 1.8 | UV-2 | 0.8 | — | — | 25 | A | 1406 | 31 | B | Example |
| 6 | 2.88 | P-3 | 12 | UV-1 | 1.8 | UV-2 | 0.8 | — | — | 25 | A | 1029 | 6 | A | Example |
| 7 | 2.88 | P-1 | 12 | UV-2 | 1.8 | UV-3 | 0.8 | — | — | 25 | A | 1240 | 19 | A | Example |
| 8 | 2.88 | P-1 | 8 | UV-1 | 1.8 | UV-2 | 0.8 | — | — | 25 | A | 1343 | 21 | A | Example |
| 9 | 2.88 | P-1 | 6 | UV-1 | 1.8 | UV-2 | 0.8 | — | — | 25 | A | 1446 | 22 | B | Example |
| 10 | 2.88 | P-2 | 6 | UV-1 | 1.8 | UV-2 | 0.8 | — | — | 25 | A | 1446 | 24 | B | Example |
| 11 | 2.88 | P-4 | 6 | UV-1 | 1.8 | UV-2 | 0.8 | — | — | 25 | A | 1640 | 27 | B | Example |
| 12 | 2.88 | P-3 | 6 | UV-1 | 1.8 | UV-2 | 0.8 | — | — | 25 | A | 1200 | 10 | B | Example |
| 13 | 2.88 | P-1 | 12 | UV-1 | 1.8 | UV-2 | 0.8 | L-1 | 3.0 | 25 | A | 1160 | 35 | A | Example |
| 14 | 2.88 | P-1 | 12 | UV-1 | 3.6 | UV-2 | 1.5 | L-1 | 3.0 | 25 | A | 1040 | 35 | A | Example |
| 15 | 2.88 | P-1 | 12 | UV-1 | 3.6 | UV-2 | 1.5 | L-2 | 3.0 | 25 | A | 1040 | 35 | A | Example |
| 16 | 2.88 | P-2 | 12 | UV-1 | 3.6 | UV-2 | 1.5 | L-1 | 3.0 | 25 | A | 1040 | 35 | A | Example |
| 17 | 2.88 | P-4 | 12 | UV-1 | 3.6 | UV-2 | 1.5 | L-1 | 1.0 | 25 | A | 1300 | 35 | A | Example |
| 18 | 2.88 | P-1 | 12 | UV-1 | 3.6 | UV-2 | 1.5 | L-1 | 5.0 | 25 | A | 1010 | 45 | A | Example |
| 19 | 2.88 | P-1 | 12 | UV-1 | 1.9 | UV-4 | 0.5 | — | — | 25 | A | 1240 | 20 | A | Compar. |
| | | | | | | | | | | | | | | | Ex. |
| 20 | 2.88 | P-1 | 12 | UV-1 | 2.6 | — | — | — | — | 25 | B | 1240 | 20 | A | Compar. |
| | | | | | | | | | | | | | | | Ex. |
| 21 | 2.88 | P-1 | 12 | UV-5 | 2.6 | — | — | — | — | 25 | B | 1240 | 20 | A | Compar. |
| | | | | | | | | | | | | | | | Ex. |
| 22 | 2.88 | P-1 | 4 | UV-1 | 1.8 | UV-2 | 0.8 | — | — | 25 | A | 2000 | 22 | C | Compar. |
| | | | | | | | | | | | | | | | Ex. |
| 23 | 2.88 | P-1 | 12 | UV-1 | 1.8 | UV-2 | 0.8 | — | — | 35 | A | 886 | 27 | A | Compar. |
| | | | | | | | | | | | | | | | Ex. |
| 24 | 2.88 | P-1 | 12 | UV-1 | 1.8 | UV-2 | 0.8 | — | — | 13 | A | 2385 | 10 | C | Compar. |
| | | | | | | | | | | | | | | | Ex. |
| 25 | 2.88 | P-1 | 6 | UV-1 | 1.8 | UV-4 | 0.8 | — | — | 40 | A | 1014 | 30 | A | Compar. |
| | | | | | | | | | | | | | | | Ex. |
| 26 | 2.88 | P-1 | 12 | UV-1 | 3.6 | UV-2 | 1.5 | — | — | 25 | A | 1240 | 21 | A | Example |
| 27 | 2.88 | P-1 | 12 | UV-1 | 2.6 | UV-2 | 2.6 | — | — | 25 | A | 1240 | 20 | A | Example |
| 28 | 2.88 | P-1 | 12 | UV-1 | 1.5 | UV-2 | 3.6 | — | — | 25 | A | 1240 | 20 | A | Example |

Ultraviolet Absorbents
[Chem. 22] 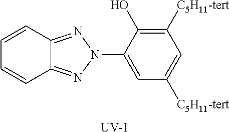
[Chem. 23] 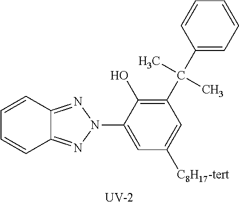
[Chem. 24] 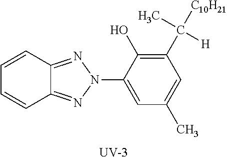
[Chem. 25] 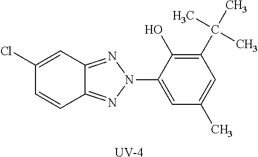 [SMILES: Cc1cc(-n2nc3ccc(Cl)cc3n2)c(O)c(C(C)(C)C)c1 ; "UV-4"]
[Chem. 26]

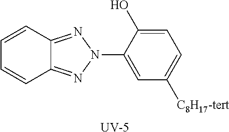

P-1 is a 2:1 (by mass) mixture of triphenyl phosphate (TPP) and biphenyldiphenyl phosphate (BDP).

P-2 is a condensate produced from a 1:1:2 (by mole) mixture of terephtahlic acid, adipic acid and ethanediol, and that having both ends estrified by acetic acid. The number average molecular weight of this condensate was found to be 1,200.

P-3 is an aromatic ester compound shown below.

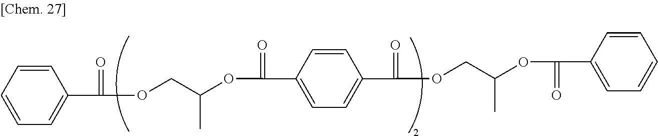

P-4 is a sugar ester compound shown below. The average substitution degree of R therein was found to be 6.

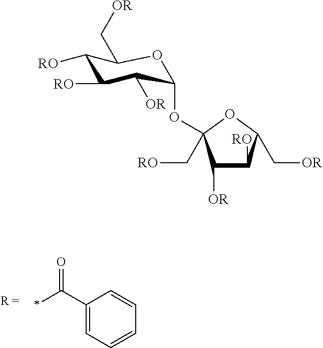

Retardation Raising Agents

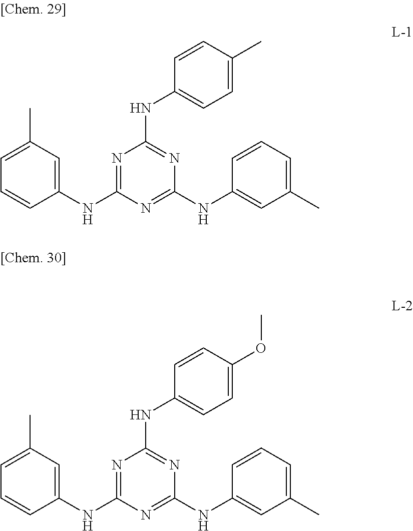 [SMILES: Cc1ccc(Nc2nc(Nc3cccc(C)c3)nc(Nc3cccc(C)c3)n2)cc1 ; COc1ccc(Nc2nc(Nc3cccc(C)c3)nc(Nc3cccc(C)c3)n2)cc1]

The cellulose acylate film #25 was too thick to be used for small- and medium-sized LCDs.

### (Transmittance Measurement)

Transmittance measurements were carried out on the cellulose acylate films by means of a spectrophotometer UV3150 (made by Shimadzu Corporation), and thereby it was confirmed that all the films had a transmittance of 22% or lower at a wavelength of 380 nm.

### (Evaluation of Whitening by Saponification)

In a potassium hydroxide solution prepared so as to have a normality of 4.0, each of the cellulose acylate films was immersed for 12 hours at 25° C. Then the film was cleaned in a washing bath, and subjected to neutralization with 0.1N sulfuric acid at 30° C. The thus treated film was cleaned again in a washing bath at room temperature, and further dried with a 120° C. hot air. The thus dried film was allowed to stand for 2 hours in 25° C. and 60% RH surroundings, and then subjected to visual observation of whitening level.

A: No whitening is observed.

B: Bleedout is observed.

### (Moisture Permeability Measurement)

As to moisture permeability, the weight of water vapor having passed through a cellulose acylate film sample with an area of 1 m² for 24 hours in an atmosphere having a temperature of 40° C. and a relative humidity of 90% was measured in conformance with JIS Z0208 Moisture Permeability Testing (cup method).

### (Rth Measurement)

The retardation in the thickness direction (Rth) at a measurement wavelength of 590 nm was determined according to the method described in the main body of this description.

### (Making of Polarizing Plate)

Each of the present cellulose acylate films prepared in Examples was immersed in a 4.0N potassium hydroxide solution at 50° C. for 30 seconds, cleaned in a washing tank at room temperature, and subjected to neutralization with 0.1N sulfuric acid at 30° C. The thus treated film was cleaned again in a washing tank at room temperature, and further dried with a 120° C. hot air.

Next, a roll of 80 μm-thick polyvinyl alcohol film was stretched continuously to 5 times its original length in an aqueous iodine solution, and then dried. In this way, a polarizing film was prepared. And a sheet of alkali-saponified cellulose acetate film now on the market (FUJITAC TD60UL, produced by FUJI Corporation) was also prepared for use. This film and each of the cellulose acylate films treated in the foregoing manner were united together in a state of sandwiching the polarizing film between them by using a 3% aqueous solution of polyvinyl alcohol (PVA-117H, produced by Kuraray Co., Ltd.) as an adhesive, thereby making a polarizing plate both surfaces of which were protected with cellulose acylate films. Herein, these cellulose acylate films were stuck so that the MD direction of the film on either side became parallel with the stretching direction of the polarizing film.

In the making of a polarizing plate, the polarizing plate using the cellulose acylate film #23 required a drying time about 1.2 times longer than that required by the polarizing plate using the cellulose acylate film #1 until these plates became equal in water content, and suffered a reduction in productivity.

### (Durability Evaluation of Polarizing Plate in Humid and Hot Surroundings)

Each of the polarizing plates made in the foregoing manner was bonded to a 0.75 mm-thick glass plate by the use of a pressure-sensitive adhesive so that the FUJITAC was situated on the glass plate side, and thereby an evaluation sample was prepared. Each of the evaluation sample thus prepared was set in a spectrophotometer VAP-7070 (made by JASCO Corporation) so that the glass plate was situated on the light-receptive side, and thereon an orthogonal transmittance measurement at a wavelength of 410 nm was made. Thereafter, each evaluation sample was subjected to moisture-and-heat treatment for 500 hours in 60° C. and 90% RH surroundings, and thereon the orthogonal transmittance measurement was made again by means of the VAP-7070. A differential between the orthogonal transmittances of each polarizing plate measured at the initial stage of and after the moisture-and-heat treatment was graded as follows.

| Transmittance Differential | Grade |
|---|---|
| 0.3% or smaller | A |
| Greater than 0.3% and smaller than 0.5% | B |
| Greater than 0.5% | C |

### <Making of TN Liquid Crystal Display Device>

A pair of polarizing plates (an upper-side polarizing plate and a lower-side polarizing plate) mounted in a liquid crystal display device utilizing a TN-mode liquid crystal cell (AS5750, made by ACER Incorporated) was peeled away, and in place thereof the polarizing plate made using the cellulose acylate film #1 was bonded to each of the viewing side (observer side) and the backlight side of the liquid crystal cell by the use of a pressure-sensitive adhesive so that the cellulose acylate film #1 was situated on the liquid crystal cell side. At this time, the polarizing plates were configured so that the transmission axis of the backlight-side polarizing plate (upper-side polarizing plate) and that of the observer-side polarizing plate (lower-side polarizing plate) become orthogonal to each other.

Likewise, the polarizing plate made using the cellulose acylate film #13 was bonded to each of the viewing side (observer side) and the backlight side of the liquid crystal cell by the use of a pressure-sensitive adhesive so that the cellulose acylate film #13 was situated on the liquid crystal cell side. At this time, the polarizing plates were configured so that the transmission axis of the backlight-side polarizing plate (upper-side polarizing plate) and that of the observer-side polarizing plate (lower-side polarizing plate) become orthogonal to each other.

### <Display Performance Evaluation>

Next, the foregoing liquid crystal display devices which had been allowed to stand for one week in a room controlled to 25° C.-60% RH were rated in categories of tint, brightness and contrast on a scale of 8, from black display (L0) to white display (L7).

### <Evaluation Result>

When contrasts of each display device were measured on the right and left sides, the liquid crystal display device having the polarizing plates made using the cellulose acylate film #13 showed a better result than the liquid crystal display device having the polarizing plates made using the cellulose acylate film #1.

### INDUSTRIAL APPLICABILITY

According to the invention, it is possible to provide a cellulose acylate film containing no halogen element and causing no whitening during a saponification process even when the film has a reduced thickness.

In addition to such a characteristic, the present cellulose acylate film excels in both moisture permeability and durability under humid and hot conditions, and it is therefore expected that the present cellulose acylate film will be used as an excellent polarizing plate protective film.

Further, it is also possible to provide low-profile polarizing plates and liquid crystal display devices through the use of the present cellulose acylate film. By performing, in particular, retardation adjustment of the cellulose acylate film, liquid crystal display devices which excel in viewing angle and contrast can be delivered.

The invention has been illustrated in detail and by reference to specific embodiments. However, it is apparent to persons skilled in the art that various changes and modifications can be made without departing from the spirit and scope of the invention.

The present application is based on Japanese Patent Application (Japanese Patent Application No. 2012-104200) filed on Apr. 27, 2012, Japanese Patent Application (Japanese Patent Application No. 2012-158063) filed on Jul. 13, 2012 and Japanese Patent Application (Japanese Patent Application No. 2013-092986) filed on Apr. 25, 2013, the contents of which are incorporated herein by reference.

1. A cellulose acylate film, comprising:
a plasticizer and
two or more kinds of ultraviolet absorbents represented by the following Formula (1): 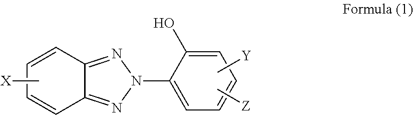
wherein X represents a hydrogen atom, an alkyl group, an alkoxy group, a hydroxyl group, an amino group or an amido group, which may further have a substituent,
in at least one kind of the ultraviolet absorbents, each of Y and Z in Formula (1) independently represents an alkyl group and the alkyl group represented by Y and Z has no aromatic ring as a substituent thereof, and
in at least one kind of the ultraviolet absorbents, each of Y and Z in Formula (1) independently represents an alkyl group and the alkyl group represented by Y and Z has one aromatic ring as a substituent thereof, and
the cellulose acylate film has a moisture permeability of 1,000 g/m²·day to 1,700 g/m²·day at a temperature of 25° C. and relative humidity of 60%.

2. The cellulose acylate film as claimed in claim 1,
wherein the film has a thickness of 15 μm to 40 μm.

3. The cellulose acylate film as claimed in claim 1,
wherein the plasticizer is a mixture of triphenyl phosphate and biphenyl phosphate.

4. The cellulose acylate film as claimed in claim 1,
wherein the plasticizer is a plasticizer which has repeating units comprising dicarboxylic acids and diols and is 700 to 10,000 in number average molecular weight.

5. The cellulose acylate film as claimed in claim 4,
wherein the plasticizer is a plasticizer formed from at least one kind of diol selected from an aliphatic diol having a carbon number of 2 to 12, an alkyl ether diol having a carbon number of 4 to 20 or an aromatic ring-containing diol having a carbon number of 6 to 20 and at least one kind of aromatic dicarboxylic acid having a carbon number in a range of 8 to 20.

6. The cellulose acylate film as claimed in claim 1,
wherein the plasticizer is a plasticizer containing a sugar ester.

7. The cellulose acylate film as claimed in claim 1, further containing a retardation raising agent.

8. A polarizing plate, containing at least one cellulose acylate film as claimed in claim 1.

9. A liquid crystal display device, containing at least one polarizing plate claimed in claim 8.

10. A method of manufacturing a polarizing plate, comprising a process in which at least one sheet of the cellulose acylate film as claimed in claim 1 and a polarizer are bonded together.
